(19) United States
(12) Patent Application Publication
(10) Pub. No.: US 2017/0365855 A1
(43) Pub. Date: Dec. 21, 2017

(54) LITHIUM BATTERY

(71) Applicants: SAMSUNG ELECTRONICS CO., LTD., Suwon-si (KR); Samsung SDI Co., Ltd., Yongin-si (KR)

(72) Inventors: Saebom RYU, Suwon-si (KR); Yonggun LEE, Suwon-si (KR); Taehwan YU, Seongnam-si (KR)

(21) Appl. No.: 15/371,479

(22) Filed: Dec. 7, 2016

(30) Foreign Application Priority Data
Jun. 21, 2016 (KR) 10-2016-0077560

(51) Int. Cl. H01M 4/62; H01M 4/36; H01M 10/052; H01M 4/02

(52) U.S. Cl. CPC H01M 4/62; H01M 10/052; H01M 4/366; H01M 2004/028

(57) ABSTRACT

A lithium battery including a negative electrode, a protected positive electrode, and an electrolyte disposed between the negative electrode and the protected positive electrode, wherein the protected positive electrode includes a positive electrode including a positive active material, and a protective layer disposed on the positive electrode, and wherein the protective layer includes a boron-containing anion receptor and a block copolymer.

### CROSS-REFERENCE TO RELATED APPLICATION

This application claims priority to Korean Patent Application No. 10-2016-0077560, filed on Jun. 21, 2016, in the Korean Intellectual Property Office, and all the benefits accruing therefrom under 35 U.S.C. §119, the content of which is incorporated herein in its entirety by reference.

### BACKGROUND

### 1. Field

The present disclosure relates to a lithium battery, and more particularly, to a lithium battery including a protected positive electrode.

### 2. Description of the Related Art

Along with the trend towards small, high-performance devices, manufacturing a small and lightweight lithium battery that has high energy density is becoming more important. That is, high-voltage, high-capacity lithium batteries are becoming more important.

A conventional positive electrode may react with an electrolyte solution during a charging and discharging process, and the reaction may produce byproducts, such as a transition metal released from a positive active material, gas, or the like. Such side reactions and produced byproducts may become more predominant at high voltage.

Therefore, there is a need for a positive electrode and a lithium battery that may be stable at high voltage with reduced side reactions and byproducts produced at high voltage.

### SUMMARY

Provided is a lithium battery including a protected positive electrode that may be stable at high voltage.

Additional aspects will be set forth in part in the description which follows and, in part, will be apparent from the description, or may be learned by practice of the presented embodiments.

According to an aspect of an embodiment, a lithium battery includes:

a negative electrode;

a protected positive electrode; and

an electrolyte disposed between the negative electrode and the protected positive electrode,

wherein the protected positive electrode includes:

a positive electrode including a positive active material; and

a protective layer disposed on the positive electrode, and

wherein the protective layer includes a boron-containing anion receptor and a block copolymer.

In some embodiments, the boron-containing anion receptor may have a boron-containing Lewis acid structure.

In some other embodiments, the boron-containing anion receptor may include at least one compound selected from a borane compound, a borate compound, and a boron oxalate compound, each having a Lewis acid structure.

According to an aspect of another embodiment, a positive electrode slurry composition includes a positive active material, a boron-containing anion receptor, and a block copolymer.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic diagram of a lithium battery according to an embodiment;

FIG. 2 is a schematic diagram of a lithium battery according to another embodiment;

FIG. 3 are images illustrating the results of scanning electron microscopy-energy dispersive spectroscopy (SEM-EDS) on a cross-section of a protected positive electrode of Comparative Example 2;

FIG. 4 are images illustrating the results of SEM-EDS on a cross-section of a protected positive electrode of Example 1;

FIG. 5 are images illustrating the results of SEM-EDS on a cross-section of a protected positive electrode of Example 2;

FIG. 6 is a graph of imaginary impedance Z″ (ohms, ohm) versus real impedance Z′ (ohms, ohm), which is a Nyquist plot showing the results of impedance measurement on lithium batteries of Comparative Example 1 and Examples 1 and 2;

FIG. 7 is a graph of imaginary impedance Z″ (ohms, ohm) versus real impedance Z′ (ohms, ohm), which is a Nyquist plot showing the results of impedance measurement on lithium batteries of Comparative Examples 3 to 5 using anion receptor-containing electrolyte solutions;

FIG. 8 is a graph of discharge capacity (milliampere hours per gram) versus cycle number illustrating the results of lifetime characteristic evaluation on the lithium batteries of Comparative Example 1 and Examples 1 and 2;

FIG. 9 is a graph of discharge capacity (milliampere hours per gram) versus cycle number illustrating the results of lifetime characteristic evaluation at high rate on the lithium batteries of Comparative Example 1 and Examples 1 and 2; and

FIG. 10 is a graph illustrating the results of lifetime characteristic evaluation on the lithium batteries of Comparative Examples 3 to 5 using the anion receptor-containing electrolyte solutions.

### DETAILED DESCRIPTION

Reference will now be made in detail to embodiments of a lithium battery, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present disclosure. As used herein, the term “and/or” includes any and all combinations of one or more of the associated listed items. Expressions such as “at least one of,” when preceding a list of elements, modify the entire list of elements and do not modify the individual elements of the list.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

The term “or” means “and/or.” As used herein, the terms such as “comprising”, “including”, “having”, or the like are intended to indicate the existence of the features regions, integers, steps, operations, components, and/or elements disclosed in the specification, and are not intended to preclude the possibility that one or more other features or elements may exist or may be added.

It will also be understood that when an element such as a layer, a region or a component is referred to as being “on” another layer or element, it can be directly on the other layer or element, or intervening layers, regions, or components may also be present. In contrast, when an element is referred to as being “directly on” another element, there are no intervening elements present.

In the drawings, the sizes of elements are exaggerated or reduced for ease of description. The size or thickness of each element shown in the drawings are arbitrarily illustrated for better understanding or ease of description, and thus the present disclosure is not limited thereto.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Hereinafter, with reference to attached drawings, a lithium battery including a protected positive electrode according to an exemplary embodiment will be described in detail. However, these are for illustrative purposes only and are not intended to limit the scope of this disclosure.

According to an aspect of the present disclosure, a lithium battery includes:

a negative electrode;

a protected positive electrode; and
an electrolyte disposed between the negative electrode and the protected positive electrode,
wherein the protected positive electrode includes:
a positive electrode including a positive active material; and
a protective layer disposed on the positive electrode,
wherein the protective layer includes a boron-containing anion receptor and a block copolymer.

The components of the protective layer may be impregnated to the inside of the positive electrode, not only on a surface of the positive electrode, to protect the entire positive electrode.

In general, when a driving voltage of a positive electrode is high with respect to lithium, an electrolytic solution may be decomposed by reduced oxidation stability of the electrolyte solution, and the components of a positive active material, for example, transition metal, oxygen, and the like may be released and deposited on a surface of a negative electrode, consequentially deteriorating battery performance. Secondarily, the released components of the positive electrode may also decompose the components of the electrolyte, such as a solvent or a lithium salt, and thus, may further deteriorate the battery performance.

However, the lithium battery according to an embodiment may include a protective layer on the positive electrode, wherein the protective layer includes a boron-containing anion receptor and a block copolymer, to physically and chemically enhance an interface between the positive electrode and the electrolyte against a high voltage and suppress such problems as described above that may occur in the interface between the positive electrode and the electrolyte, thus improving the lifetime characteristics of the lithium battery.

The block polymer of the protective layer may have good stability against high voltages, good stability in a liquid electrolyte, and high strength durable enough to maintain the shape of the protective layer with a thin film thickness even after immersion of the electrolyte. The boron-containing anion receptor of the protective layer may have a boron-containing Lewis acid structure, i.e., a boron atom of the anion receptor may have a vacant orbital capable of accepting electrons from an electron donor molecule (for example, an anion or a heteroatom having a lone pair of electrons). The boron-containing anion receptor of the protective layer having a boron-containing Lewis acid structure may bind with anions of the lithium salt and stabilize the anions to suppress decomposition of the anions of the lithium salt that may likely occur on the high voltage surface of a positive active material. Furthermore, the anions of the lithium salt distributed in the boron-containing anion receptor may inhibit corrosion of a positive electrode current collector. The boron-containing anion receptor may improve ion conductivity between the positive electrode and the electrolyte and lithium ion conductivity.

Thus, the protected positive electrode including the protective layer including a boron-containing anion receptor and a block copolymer on a positive electrode may improve the lifetime characteristics of a lithium battery including a high voltage positive active material.

In some embodiments, the boron-containing anion receptor may include at least one compound selected from a borane compound, a borate compound, and a boron oxalate compound, each having a Lewis acid structure. In other embodiment, the boron-containing anion receptor may be a boron malonate compound.

In some embodiments, the boron-containing anion receptor may include at least one of compounds represented by Formula 1 to Formula 3.

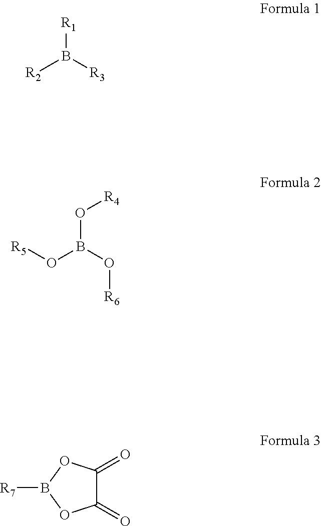

In Formulae 1, 2, and 3,

R₁ to R₇ may be each independently a substituted or unsubstituted C1-C20 alkyl group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 aryl alkyl group, a substituted or unsubstituted C2-C20 heteroaryl group, a substituted or unsubstituted C2-C20 hetero aryloxy group, a substituted or unsubstituted C2-C20 heteroaryl alkyl group, a substituted or unsubstituted C4-C20 carbocyclic group, a substituted or unsubstituted C4-C20 carbocyclic alkyl group, a substituted or unsubstituted C2-C20 heterocyclic group, a substituted or unsubstituted C2-C20 heterocyclic alkyl group, a cyano group, a hydroxyl group, a cyano group, an amino group, an amidino group, a hydrazine group, a hydrazone group, a nitro group, a thiol, a phosphate, a silyl group, a carboxyl group or a salt thereof, a sulfonyl group, a sulfamoyl group, a sulfonic acid group or a salt thereof, a phosphoric acid group or a salt thereof.

In the borane compound represented by Formula 1, R₁ to R₃ may be each independently, for example, a substituted or unsubstituted C1-C20 alkyl group or a substituted or unsubstituted aryl group. In Formula 1, R₁ to R₃ may be substituted with fluorine. For example, in Formula 1, R₁ to R₃ may be each independently a methyl group, an ethyl group, a propyl group, an iso-propyl group, a butyl group, a tert-butyl group, a trifluoromethyl group, a tetrafluoroethyl group, or a pentafluorophenyl group.

In Formula 1, any two of groups R₁ to R₃ may be connected to each other to form a ring of a cyclic borane compound. For example, when R₁ and R₂ are both ethyl, groups R₁ and R₂ can form a borocyclopentane ring. In another example, when R₁ is ethyl and R₂ is propyl, groups R₁ and R₂ can form a borocyclohexane ring.

For example, the borane compound represented by Formula 1 may be tris(pentafluorophenyl) borane.

In the borate compound represented by Formula 2, R₄ to R₆ may be each independently, for example, a substituted or unsubstituted C1-C20 alkyl group, a substituted or unsubstituted aryl group, or a substituted or unsubstituted silyl group. For example, in Formula 2, R₄ to R₆ may be substituted with fluorine. For example, in Formula 2, R₄ to R₆ may be each independently a methyl group, an ethyl group, a propyl group, an iso-propyl group, a butyl group, a tert-butyl group, a trifluoromethyl group, a tetrafluoroethyl group, or a silyl group. In Formula 2, any two of groups R₄ to R₆ may be connected to each other to form a ring of a cyclic borate compound. For example, when R₄ and R₅ are both methyl, groups R₄ and R₅ can form a five-membered cyclic borate ring. In another example, when R₄ is methyl and R₅ is ethyl, groups R₄ and R₅ can form a six-membered cyclic borate ring.

For example, the borate compound represented by Formula 2 may be a borate compound represented by Formula 2a.

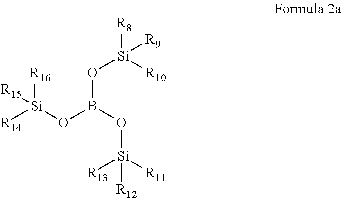

In Formula 2a, R₈ to R₁₆ may be each independently a substituted or unsubstituted C1-C20 alkyl group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 aryl alkyl group, a substituted or unsubstituted C2-C20 heteroaryl group, a substituted or unsubstituted C2-C20 hetero aryloxy group, a substituted or unsubstituted C2-C20 heteroaryl alkyl group, a substituted or unsubstituted C4-C20 carbocyclic group, a substituted or unsubstituted C4-C20 carbocyclic alkyl group, a substituted or unsubstituted C2-C20 heterocyclic group, or a substituted or unsubstituted C2-C20 heterocyclic alkyl group.

In the borate compound represented by Formula 2a, R₈ to R₁₆ may be each independently, for example, a substituted or unsubstituted C1-C20 alkyl group or a substituted or unsubstituted aryl group. For example, in Formula 2a, R₈ to R₁₆ may be substituted with fluorine. For example, in Formula 2a, R₈ to R₁₆ may be each independently a methyl group, an ethyl group, a propyl group, an iso-propyl group, a butyl group, a tert-butyl group, a trifluoromethyl group, or tetrafluoroethyl group.

For example, the borate compound represented by Formula 2 may be triphenyl borate, trimethyl borate, tris(trimethylsilyl) borate, tris(triethylsilyl) borate, or tris(hexafluoroisopropyl) borate.

In the boron oxalate compound represented by Formula 3, R₇ may be, for example, a substituted or unsubstituted C1-C20 alkyl group, or a substituted or unsubstituted aryl group. For example, in Formula 3, R₇ may be substituted with fluorine. For example, in Formula 1, R₁ to R₃ may be each independently a methyl group, an ethyl group, a propyl group, an iso-propyl group, a butyl group, a tert-butyl group, a trifluoromethyl group, a tetrafluoroethyl group, or a fluorinated phenyl group.

In some embodiments, the boron oxalate compound represented by Formula 3 may be an arylboron oxalate compound represented by Formula 3a.

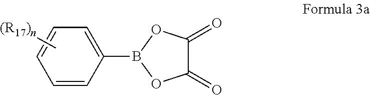

In Formula 3a, R₁₇ may be a fluorine-containing moiety and n may be 1, 2, 3, 4, or 5.

In an embodiment, the fluorine-containing moiety may be selected from a monofluoroalkyl group, a difluoroalkyl group, a trifluoroalkyl group, and a tetrafluoroalkyl group. In another embodiment, the fluorine-containing moiety may be a perfluoroalkyl group. For example, the fluorine-containing moiety may be selected from fluorine, fluoromethyl, difluoromethyl, trifluoromethyl, 1-fluoroethyl, 1,1-difluoroethyl, 1,1,2-trifluoroethyl, 1,1,2,2-tetrafluoroethyl, and 1,1,1,2-tetrafluoroethyl.

Non-limiting examples of the boron oxalate compound represented by Formula 3 may include pentafluorophenylboron oxalate, 2,4-difluorophenylboron oxalate, 2,5-difluorophenylboron oxalate, 2,3,6-trifluorophenylboron oxalate, and 3,5-bis(trifluoromethyl)phenylboron oxalate.

The arylboron oxalate compound represented by Formula 3a may include 1, 2, 3, 4, or 5 fluorine-containing moieties R₁₇.

The amount of the boron-containing anion receptor may be from about 1 to 30 parts by weight based on 100 parts by weight of the block copolymer. For example, the amount of the boron-containing anion receptor may be from about 5 to 25 parts by weight, and in some embodiments, from about 10 to 20 parts by weight, based on 100 parts by weight of the block copolymer. While not wishing to be bound by theory, it is understood that when the amount of the boron-containing anion receptor is within these ranges, the protected positive electrode may have reduced interfacial resistance, and thus, may effectively improve the lifetime characteristics of a lithium battery at high voltage.

In some embodiments, the protected positive electrode may further include a lithium salt originating from the electrolyte. As the protected positive electrode includes a lithium salt, the protective positive electrode may be provided with ion conductivity paths.

During charging and discharging of a lithium battery, lithium ions of the lithium salt may pass through the protective layer and may freely migrate between the positive electrode and the electrolyte, while anions of the lithium salt may be coordinated to the boron-containing anion receptor. As the anions are bound to the boron-containing anion receptor by coordination bonds, the anions of the lithium salt may be stabilized, so that decomposition of the anions of the lithium salt that may likely occur on the surface of the high-voltage positive active material may be suppressed or prevented.

The lithium salt may be any lithium salts that are commonly used in the art. For example, the lithium salt may be at least one selected from LiSCN, LiN(CN)₂, LiClO₄, LiBF₄, LiAsF₆, LiPF₆, LiCF₃SO₃, Li(CF₃SO₂)₂N, Li(CF₃SO₂)₃C, LiN(SO₂F)₂, LiN(SO₂C₂F₅)₂, LiN(SO₂CF₃)₂, LiN(SO₂CF₂CF₃)₂, LiSbF₆, and LiPF₃(CF₂CF₃)₃, LiPF₃(C₂F₅)₃, LiPF₃(CF₃)₃, LiB(C₂O₄)₂, NaSCN, NaSO₃CF₃, KTFSI, NaTFSI, Ba(TFSI)₂, Pb(TFSI)₂, and Ca(TFSI)₂. However, embodiments are not limited thereto.

The amount of the lithium salt in the protected positive electrode is not specifically limited. For example, the amount of the lithium salt may be about 0 to 50 parts by weight, and in some embodiments, about 0 to 30 parts by weight, and in some other embodiments, about 0 to 15 parts by weight, based on 100 parts by weight of the block copolymer. When the amount of the lithium metal is within these ranges, the protective positive electrode may have improved lithium ion mobility and improved ion conductivity.

In some embodiments, the block copolymer in the protected positive electrode may include at least one first block that forms a structural domain and at least one second block that forms an ionically conductive domain. The amount of the first block may be from about 20 parts to 80 parts by weight, and in some embodiments, from about 30 parts to 70 parts by weight, and in some other embodiments, from about 40 parts to 60 parts by weight, based on 100 parts by weight of the block copolymer, and the amount of the second block may be from about 20 parts to 80 parts by weight, and in some embodiments, from about 30 parts to 70 parts by weight, and in some other embodiments, from about 40 parts to 60 parts by weight, based on the 100 parts by weight of the block copolymer.

While not wishing to be bound by theory, it is understood that when the amounts of the first block and the second block are within these ranges, the protective layer may have improved intensity and an ion conductivity path at the same time, and thus, may effectively inhibit a side reaction between the positive electrode and the electrolyte at high voltage, so that the lithium battery may have improved high-voltage stability. When the amount of the first block exceeds the above range, due to enhanced insulating characteristics of a coating layer, an ion conductivity path may not be ensured. When the amount of the first block is below the above range, the protective layer may have reduced intensity, and may be easily swollen by the liquid electrolyte, so that a side reaction between the liquid electrolyte and the positive active material may be more likely to occur on the surface of the positive electrode.

When the amounts of the first block and the second block of the block copolymer in the protective layer are within the above ranges, the protective layer including the block copolymer may have a tensile modulus at 25° C. of about 1×10⁶ Pa or greater, and in some embodiments, about 10×10⁶ Pa or greater, and in some other embodiments, about 100×10⁶ Pa. The protective layer including the block copolymer may have a high tensile modulus at 25° C. of about 1×10⁶ Pa or greater, and thus, may maintain strong mechanical strength.

When the amounts of the first block and the second block of the block copolymer in the protective layer are within the above ranges, the protective layer including the block copolymer may have an elongation at break at 25° C. of about 100% or greater, and in some embodiments, about 130% or greater, and in some other embodiments, about 150% or greater. The protective layer including the block copolymer may have an elongation at break at 25° C. of about 100% or greater, and thus, may be maintained as a strong layer not vulnerable to cracking. The tensile modulus and elongation at break of the protective layer including the block copolymer may be measured using a sample in thin film form prepared to have the same composition as the protective layer.

The protective layer including the block copolymer in which the amounts of the first block and the second block are within any of the above ranges may have a thickness of about 1 micrometer (μm) or less, and in some embodiments, about 10 nm to 1 μm, and in some embodiments, about 10 nm to 500 nm, and in some embodiments, about 50 nm to 200 nm, and in some other embodiments, about 50 nm to 150 nm. While not wishing to be bound by theory, it is understood that when the thickness of the protective layer is within these ranges, the protective layer may have enhanced strength and ion conductivity paths. When the protective layer exceeds the above ranges, the ion induction path passing through the protective layer may have an increased length, thus increasing interfacial resistance and consequentially deteriorating battery performance.

The protective layer including the block copolymer in which the amounts of the first block and the second block are within any of the above ranges may be stable against an organic solvent and a liquid electrolyte including an organic solvent. The organic solvent may be at least one solvent selected from an ether group-containing solvent and a carbonate group-containing solvent. For example, the organic solvent may be a carbonate-based compound, a glyme-based compound, a dioxolane-based compound, dimethyl ether, or 1,1,2,2-tetrafluoroethyl 2,2,3,3-tetrafluoropropyl ether. The protective layer may be stable against such an organic solvent and a liquid electrolyte including such an organic solvent, and thus, may not have reduced strength or be dissolved even after contact with the organic solvent and liquid electrolyte for a long time.

When the block copolymer including the first block and the second block within the above ranges, and the at least one solvent selected from an ether group-containing solvent and a carbonate group-containing solvent may have a difference (Δδ) in solubility parameter of about 3 or greater. When the block copolymer and the at least one solvent selected from ether group-containing solvents and carbonate group-containing solvents have a difference (Δδ) in solubility parameter of about 3 or greater, the protective layer including the block copolymer may have improved stability against the organic solvent in the protective layer and the liquid electrolyte including the organic solvent.

A conventional coating layer is used together with a gel electrolyte including a polymer and a liquid electrolyte. However, the polymer for forming a gel electrolyte may have poor mechanical properties. Thus, when preparing a gel electrolyte using a low-strength polymer, nano inorganic particles may be further added. When nano inorganic particles are added, the gel electrolyte may have improved mechanical characteristics, but also have increased interfacial resistance.

A layer including a block copolymer that includes a polyethylene oxide block may also be used as the conventional coating layer. However, this layer may be dissolved in an electrolyte that includes an ether-based solvent and/or a carbonate-based organic solvent.

Unlike the above-described conventional coating layers, the protected positive electrode according to any of the embodiments may use a protective layer including a block copolymer in which the amounts of the first block and the second block are within the above-described ranges, to thereby have ensured strength, ductility, and elasticity, and good stability against a liquid electrolyte including an ether-based organic solvent and/or a carbonate-based organic solvent.

In the block copolymer in which the amounts of the first block and the second block are within the above ranges, at least one first block and at least one second block may each independently have a molecular weight of 5,000 Daltons or greater, and in some embodiments, about 5,000 to 150,000 Daltons, and in some embodiments, about 10,000 to 100,000 Daltons, and in some embodiments, about 25,000 to 75,000 Daltons. While not wishing to be bound by theory, it is understood that when the molecular weights of the first block and the second block are within these ranges, a protective layer that has improved strength and ion conductivity paths may be obtained.

In some embodiments, the protective layer may include an array of a plurality of block copolymers including a plurality of first blocks that form a structural domain, and a plurality of second blocks that form an ionically conductive domain. The structural domain may provide mechanical properties of the array of block copolymers. The structural domain may be relatively insulative, compared with the ionically conductive domain. The ionically conductive domain may provide an ion conductivity path in the array of block copolymers, together with the lithium salt. The second blocks in the ionically conductive domain may include, for example, an ionically conductive block, a rubbery block, and/or a nitrile group-containing block. The ionically conductive block, the rubbery block, and/or the nitrile group-containing block alone or in a combination with a lithium salt may form an ionically conductive domain and provide ion conductivity paths.

The array of block copolymers may form a domain in any of a variety of forms that vary depending on the types of the first blocks and second blocks of the block copolymers. The array of block copolymers may form a nanostructured block copolymer material.

A first block in the block copolymer may include a plurality of first repeating units. The first repeating units may form a first block responsible for mechanical properties of the block copolymer. For example, the first repeating unit may be derived from at least one monomer selected from styrene, 4-bromostyrene, tert-butylstyrene, divinylbenzene, methyl methacrylate, iso-butyl methacrylate, ethylene, propylene, dimethyl siloxane, iso-butylene, N-isopropylacrylamide, vinylidene fluoride, acrylonitrile, 4-methylpentene-1, butylene terephthalate, ethylene terephthalate, and vinyl pyridine.

The polymer including the first repeating unit as described above may be at least one selected from polystyrene, hydrogenated polystyrene, polymethacrylate, poly(methyl methacrylate), polyvinyl pyridine, polyvinylcyclohexane, polyimide, polyamide, polyethylene, polybutylene, polypropylene, poly(4-methylpentene-1), poly(butylene terephthalate), poly(iso-butyl methacrylate), poly(ethylene terephthalate), polydimethylsiloxane, polyacrylonitrile, polyvinylcyclohexane, polymaleic acid, polymaleic acid anhydride, polyamide, polymaleic acid, poly(tert-butyl vinyl ether), poly(cyclohexyl methacrylate), poly(cyclohexyl vinyl ether), polyvinylidene fluoride, and polydivinyl benzene; or a copolymer including at least two repeating units of the above-listed polymers.

For example, the first block may be a polystyrene block.

A second block in the block copolymer may include a plurality of second repeating units. For example, the second repeating units may be derived from at least one monomer selected from ethylene oxide, siloxane, acrylonitrile, isoprene, butadiene, chloroprene, iso-butylene, and urethane.

The polymer including the second repeating unit as described above may include at least one selected from polyethylene oxide, polysiloxane, polyacrylonitrile, polyisoprene, polybutadiene, polychloroprene, polyisobutylene, and polyurethane.

The first block and the second block in the block copolymer may be connected to each other by a covalent bond. The block polymer may be a linear block copolymer. The linear block copolymer may have a linear main chain as a terminal of at least one first block and a terminal of at least one second block are covalently bound to each other.

The block copolymer including at least one first block and at least one second block may be a diblock copolymer, a triblock copolymer, or a tetrablock copolymer. The block copolymer may be a linear block copolymer. For example, the block copolymer may include an array of a plurality of linear block copolymers that may constitute a strong nanostructured block copolymer material.

The diblock copolymer may include about 20 to 70 parts by weight of the first block based on 100 parts by weight of the block copolymer. For example, the total amount of the first block in the diblock copolymer may be about 20 to 50 parts by weight, and in some embodiments, about 20 to 40 parts by weight, based on 100 parts by weight of the block copolymer. For example, the diblock copolymer may include a first block (A) and a second block (B).

The triblock copolymer may include about 20 to 70 parts by weight of the first block based on 100 parts by weight of the block copolymer. For example, the total amount of the first block in the triblock copolymer may be about 30 to 70 parts by weight, and in some embodiments, about 50 to 70 parts by weight, based on 100 parts by weight of the block copolymer. For example, the triblock copolymer may include a first block (A), a second block (B), and a first block (A). For example, the triblock copolymer may include a first block (A), a second block (B), and a third block (C). For example, the triblock copolymer may include a second block (B), a first block (A), and a second block (B).

The tetrablock copolymer may include about 20 to 70 parts by weight of the first block based on 100 parts by weight of the block copolymer. For example, the total amount of the first block in the tetrablock copolymer may be about 30 to 70 parts by weight, and in some embodiments, about 50 to 70 parts by weight, based on 100 parts by weight of the block copolymer. For example, the tetrablock copolymer may include a first block (A), a second block (B), a third block (C), and a first block (A).

In some embodiments, the block copolymer may further include a polymer network. For example, when the block copolymer includes a plurality of first blocks that form a structural domain and a plurality of second blocks that form an ionically conductive domain, the polymer network may be disposed in the ionically conductive domain including the second blocks. The second blocks of the block copolymers may be penetrated in the polymer network. The block copolymers and the polymer network may not be covalently linked to each other. The polymer network may be cross-linked to between the plurality of second blocks in the ionically conductive domain, and thus, may improve strength of the ionically conductive domain. For example, when the ionically conductive domain includes only polyethylene oxide or polysiloxane-based second blocks, the ionically conductive domain may be soluble in an ether group-containing and/or a carbonate group-containing solvent that has poor stability. However, when the polymer network is introduced to the ionically conductive domain including polyethylene oxide- or polysiloxane-based second blocks, the ionically conductive domain may have improved stability against such a solvent as described above and an electrolyte including the solvent.

When the block copolymer further includes a polymer network as described above, the protective layer may have improved ion conductivity, elasticity, strength, stability against electrolyte, and high-voltage stability.

In some embodiments, the second blocks including a plurality of second repeating units that may penetrate into the polymer network may be at least one selected from polyethylene oxide, polysiloxane, polyacrylonitrile, polyisoprene, polybutadiene, polychloroprene, polyisobutylene, and polyurethane.

In some embodiments, the polymer network may be a polymerization product of a cross-linkable oligomer.

The cross-linkable oligomer may be at least one selected from diethylene glycol diacrylate (DEGDA), triethylene glycol diacrylate (TEGDA), polyethylene glycol diacrylate (PEGDA), ethoxylated trimethylolpropane triacrylate (ETPTA), hexanediol diacrylate, and an octafluoropentyl acrylate. However, embodiments are not limited thereto. Any cross-linkable oligomers available in the art may be used.

The polymerization of the cross-linkable oligomer may be performed by thermal polymerization, UV polymerization, or the like. However, embodiments are not limited thereto. Any available methods in the art of polymerizing cross-linkable oligomers to form a polymer network may be used.

The polymerization product of a cross-linkable oligomer, i.e., a polymer network, may further be present in the positive electrode, not only in the protective layer on the surface of the positive electrode. The further inclusion of the polymer network in the positive electrode may further improve physical characteristics of the positive electrode.

Due to a high mixture density of a roll-pressed positive electrode and a bulky structure of the block copolymer, it may be difficult for a coating solution including the block copolymer to permeate into the block copolymer when coated on a surface of the positive electrode, so that the block copolymer may not be present inside the polymer electrolyte. For example, the block copolymer may have a concentration gradient that sharply reduces from a surface of the positive electrode next to the electrolyte toward the opposite surface of the positive electrode adjacent to a current collector.

Meanwhile, cross-linkable oligomers having a low molecular weight and a small size may easily permeate into the positive electrode, and a polymerization product of cross-linkable oligomers polymerized by a thermal treatment or UV irradiation, i.e., a polymer network, may be present on the surface of and inside the positive electrode.

For example, the block copolymer may be at least one selected from: a block copolymer including a polystyrene first block and a polyacrylonitrile second block; a block copolymer including a polymethyl methacrylate first block and a polyacrylonitrile second block; a block copolymer including a polystyrene first block, a polyacrylonitrile second block, and a polybutadiene second block; a block copolymer including a polystyrene first block, a polyisoprene second block, and a polystyrene first block; a block copolymer including a polystyrene first block and a polybutadiene second block; a block copolymer including a polystyrene first block, a polybutadiene second block, and a polystyrene first block; a block copolymer including a polystyrene first block, a polyethylene oxide second block, a polybutadiene second block, a polystyrene first block, and a polymer network; a block copolymer including a polystyrene first block, a polyethylene oxide second block, and a polymer network; a block copolymer including a polystyrene first block, a polyethylene oxide second block, a polystyrene first block, and a polymer network; a block copolymer including a polystyrene first block, a polysiloxane second block, and a polymer network; and a block copolymer including a polystyrene first block, a polysiloxane second block, a polystyrene first block, and a polymer network.

In some embodiments, the protective layer may further include an inorganic particle. When the protective layer further includes an inorganic particle, the protective layer may have further improved mechanical characteristics and lithium ion conductivity.

The inorganic particle may be at least one selected from SiO₂, TiO₂, ZnO, Al₂O₃, BaTiO₃, cage-structured silsesquioxane, metal-organic framework (MOF) particle, Li_{1+x+y}AlₓTi₂₋ₓSi_{y}P_{3-y}O₁₂ (wherein 0<x<2 and 0≦y<3), Pb(Zr, Ti)O₃ (PZT), Pb₁₋ₓLaₓZr_{1-y} Ti_{y}O₃ (PLZT) (wherein 0≦x<1 and 0≦y<1), PB (Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, SiC, lithium phosphate (Li₃PO₄), lithium titanium phosphate (LiₓTi_{y}(PO₄)₃, wherein 0<x<2 and 0<y<3), lithium aluminum titanium phosphate (LiₓAl_{y}Ti_{z}(PO₄)₃, wherein 0<x<2, 0<y<1, and 0<z<3), Li_{1+x+y}(Al, Ga)ₓ(Ti, Ge)₂₋ₓSi_{y}P_{3-y}O₁₂ (wherein 0≦x≦1 and 0≦y≦1), lithium lanthanum titanate (LiₓLa_{y}TiO₃, wherein 0<x<2 and 0<y<3), lithium germanium thiophosphate (LiₓGe_{y}P_{z}S_{w}, wherein 0<x<4, 0<y<1, 0<z<1, and 0<w<5), lithium nitride (LiₓN_{y}, wherein 0<x<4 and 0<y<2), SiS₂ (LiₓSi_{y}S_{z}, wherein 0<x<3, 0<y<2, and 0<z<4)-based glass, P₂S₅ (LiₓP_{y}S_{z}, wherein 0<x<3, 0<y<3, and 0<z<7)-based glass, Li₂O, LiF, LiOH, Li₂CO₃, LiAlO₂, Li₂O—Al₂O₃—SiO₂—P₂O₅—TiO₂—GeO₂-based ceramics, and garnet-based ceramics (Li₃₊ₓLa₃M₂O₁₂, wherein M may be at least one of Te, Nb, and Zr).

The inorganic particle may have an average particle diameter of about 1 μm or less, and in some embodiments, about 500 nm, and in some embodiments, about 100 nm or less, and in some embodiments, about 1 nm to 100 nm, and in some embodiments, about 5 nm to 100 nm, and in some other embodiments, about 10 nm to 100 nm, and in some other embodiments, about 10 nm to 70 nm, and in some other embodiments, about 30 nm to 70 nm. While not wishing to be bound by theory, it is understood that when the inorganic particle has an average particle diameter within these ranges, the protective layer may have improved ion conductivity and improved mechanical characteristics.

The protective layer may be non-porous. The non-porous protective layer may effectively block side reactions between a surface of the positive electrode and the electrolyte. The nonporous protective layer means that pores are not intentionally included in the protective layer.

The protective layer may totally or partially coat a surface of the positive electrode. For example, the protective layer may effectively protect the positive electrode by totally coating the surface of the positive electrode to completely block contact between the positive electrode and the electrolyte.

In some embodiments, in the positive electrode of the protected positive electrode, the amount of a positive active material in the positive electrode may be about 90 parts by weight or greater based on 100 parts by weight of a total weight of the positive electrode. For example, the amount of the positive active material may be about 92 to 99 parts by weight, and in some embodiments, about 95 to 99 parts by weight, and in some embodiments, about 97 to 99 parts by weight, based on 100 parts by weight of the total weight of the positive electrode. As the positive electrode includes 90 parts by weight or greater of the positive active material, the positive electrode may have improved energy density.

In some other embodiments, instead of such a separate protective layer formed on the positive electrode from a boron-containing anion receptor and a block copolymer, as described above, a boron-containing anion receptor and a block copolymer may be added to a positive electrode slurry including a positive active material, to incorporate the boron-containing anion receptor and the block copolymer into the positive electrode. When forming a positive electrode with a positive electrode slurry prepared by adding the boron-containing anion receptor and the block copolymer thereto, a protective layer in the form of a positive electrode thin film may be formed between the positive electrode and the electrolyte during a charging and discharging process.

In some other embodiments, the boron-containing anion receptor and the block copolymer may be included both in the protective layer on the positive electrode and inside the positive electrode.

For example, a positive electrode slurry composition for preparing the positive electrode may include about 0.1 to 50 parts by weight of the boron-containing anion receptor and about 0.1 to 50 parts by weight of the block copolymer, each based on 100 parts by weight of the positive active material. While not wishing to be bound by theory, it is understood that when the amounts of the boron-containing anion receptor and the block copolymer are within these ranges, a positive electrode thin film with enhanced physical and chemical characteristics may be formed on the interface between the high-voltage positive electrode and the electrolyte. When the positive electrode slurry composition includes a binder as usual, the amount of the block copolymer may be reduced.

As the protected positive electrode including the protective layer on the positive electrode is used, the lithium battery may have improved high-voltage stability, stability against electrolyte, and/or lifetime characteristics.

In some embodiments, the electrolyte between the protected positive electrode and the negative electrode may include a liquid electrolyte, a gel electrolyte, a solid polymer electrolyte, a solid inorganic electrolyte, or a combination thereof. For example, the electrolyte may be a liquid electrolyte. For example, the electrolyte may further include a solid electrolyte or a gel electrolyte, together with a liquid electrolyte.

The negative electrode may include a lithium metal or a lithium metal alloy substrate.

For example, as the negative electrode, a lithium metal or lithium metal alloy thin film may be used. The lithium metal or lithium metal alloy thin film may have a thickness of about 100 μm or less. For example, the lithium battery may have stable cycle characteristics with a lithium metal or lithium metal alloy thin film having a thickness of about 100 μm or less. For example, the lithium metal of lithium metal alloy thin film in the lithium battery may have a thickness of about 80 μm or less, and in some embodiments, about 60 μm or less, and in some other embodiments, about 0.1 to 60 μm.

The negative electrode substrate may further include a block copolymer-containing protective layer disposed on a surface thereof. The block copolymer of the protective layer on the surface of the negative electrode substrate may include at least one first block that forms a structural domain and at least one second block that forms an ionically conductive domain, wherein the amount of the at least one first block may be about 20 to 80 parts by weight based on 100 parts by weight of the block copolymer. As the block copolymer-containing protective layer including the at least one first block within the above amount range is on the surface of the negative electrode substrate, the lithium battery may have further improved high-voltage stability and lifetime characteristics.

In some embodiments, the lithium battery may have a charging voltage of about 4.0 to 5.5 V with respect to lithium metal. For example, the lithium battery may have a charging voltage of about 4.2 to 5.0 V, and in some embodiments, about 4.3 to 5.0 V, and in some embodiments, about 4.4 to 5.0 V, and in some other embodiments, about 4.5 to 5.0 V, with respect to lithium metal. Therefore, the lithium battery may be stable during charging and discharging at a high voltage of about 4.0 V or greater with respect to lithium metal, and thus, have improved energy density.

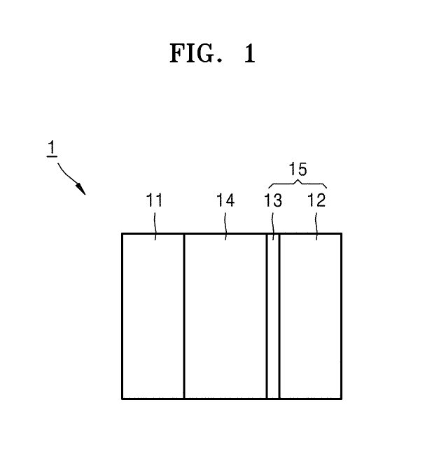

FIG. 1 is a schematic diagram of a lithium battery 1 according to an embodiment. Referring to FIG. 1, a lithium battery 1 according to an embodiment may include a negative electrode 11, a positive electrode 12, and a protected positive electrode 15 including a protective layer 13 on a positive electrode 12. An electrolyte 14 may be disposed between the negative electrode 11 and the protective layer 13. The electrolyte 14 may include an electrolyte having a different composition from the protective layer 13, a separator, or the like. In FIG. 1, the thickness of the protective layer 13 is exaggerated for clear distinction from the positive electrode 12. However, the thickness of the protective layer 13 may be smaller than illustrated.

In some embodiments, in the lithium battery 1, the protective layer 13 may be on at least part of the positive electrode 12 to electrochemically and mechanically stabilize the surface of the positive electrode 12 adjacent to the electrolyte 14. Thus, a side reaction on the surface of the positive electrode 12 may be suppressed during charging and discharging of the lithium battery 1, so that the interfacial stability between the positive electrode 12 and the electrolyte 14 may be improved, with uniform current distribution on the surface of the protected positive electrode 15. Consequentially, the lithium battery 1 may have improved cycle characteristics.

For example, the protective layer 13 may totally coat the entire surface of the positive electrode 12 to prevent direct contact between the surface of the protective electrode 12 and the electrolyte 14, consequentially protecting the positive electrode 12 and improving the stability of the positive electrode 12. Although not illustrated, the protective layer 13 may also be on a surface of the negative electrode 11, to thereby further improve the stability of the lithium battery 1. The thickness and composition of a protective layer on the surface of the negative electrode 11 may be the same or different from those of the protective layer 13 on the surface of the positive electrode 12.

For example, a lithium battery according to an embodiment including a protected positive electrode including a protective layer on a positive electrode may be manufactured as follows.

First, a negative electrode is prepared.

As the negative electrode, a lithium metal or lithium metal alloy thin film may be used alone. In some embodiments, the negative electrode may include a conductive substrate as a current collector and a lithium metal or lithium metal alloy thin film disposed on the current collector. The lithium metal or lithium alloy thin film may be integrally formed with the current collector. In some other embodiments, the negative electrode may include a current collector and a negative active material layer on the current collector.

The current collector of the negative electrode may include at least one selected from stainless steel, copper, nickel, iron, and cobalt. However, embodiments are not limited thereto. Any metallic substrate with good conductivity available in the art may be used. For example, the current collector may be a conductive oxide substrate or a conductive polymer substrate. The current collector may have any of a variety of structures, for example, a structure including a substrate that is completely formed of a conductive material, or a structure including conductive metal, conductive metal oxide, or conductive polymer coated on a surface of an insulating substrate. The current collector may be a flexible substrate. For example, the current collector may be easily bent or folded, and be restored back to the original shape thereof.

The negative electrode may further include an additional negative active material, in addition to a lithium metal or a lithium metal alloy thin film. The negative electrode may include an alloy of lithium metal with other negative active material, a composite of lithium metal and other negative active material, or a mixture of lithium metal and other negative active material.

For example, the additional negative active material that may be added to the negative electrode may include at least one selected from a metal alloyable with lithium, a transition metal oxide, a non-transition metal oxide, and a carbonaceous material.

For example, the metal alloyable with lithium may be Si, Sn, Al, Ge, Pb, Bi, Sb, a Si—Y alloy (wherein Y may be an alkaline metal, an alkaline earth metal, a Group 13 element, a Group 14 element, a transition metal, a rare earth element, or a combination of these elements, but not Si), or a Sn—Y alloy (wherein Y may be an alkaline metal, an alkaline earth metal, a Group 13 element, a Group 14 element, a transition metal, a rare earth element, or a combination thereof, but not Sn). For example, Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

For example, the transition metal oxide may be a lithium titanium oxide, a vanadium oxide, a lithium vanadium oxide, or the like.

For example, the non-transition metal oxide may be SnO₂ or SiOₓ (wherein 0<x<2).

Examples of the carbonaceous material are crystalline carbon, amorphous carbon, and a combination thereof. Examples of the crystalline carbon are graphite, such as natural graphite or artificial graphite that are in shapeless (i.e., irregular), plate, flake, spherical, or fibrous form. Examples of the amorphous carbon are soft carbon (carbon sintered at low temperatures), hard carbon, meso-phase pitch carbides, and sintered cokes.

In some embodiments, the negative electrode may include a negative active material, instead of lithium metal. The negative electrode may be prepared using, instead of lithium metal, a negative electrode slurry composition including a negative active material, a conducting agent, a binder, and a solvent that are commonly used in the art.

For example, after a conventional negative electrode slurry composition is prepared, the negative electrode slurry composition may be directly coated on a current collector and dried, to thereby manufacture a negative electrode plate. In some embodiments, the conventional negative electrode slurry composition may be cast on a separate support to form a negative active material film. The negative active material film may then be separated from the support and then laminated on a current collector, to thereby manufacture a negative electrode plate. The negative electrode is not limited to the above-listed forms. The negative electrode may be of any of a variety of shapes available in the art. For example, the negative electrode may be manufactured by printing a negative active material ink including a conventional negative active material, an electrolyte solution, and the like onto a current collector by, for example, inkjet printing. The conventional negative active material may be in powder form. The conventional negative active material in powder form may be used in the negative electrode slurry composition or negative active material ink.

In some embodiments, the conducting agent may be carbon black or graphite particulates. However, embodiments are not limited thereto. Any material available as a conducting agent in the art may be used.

Examples of the binder are a vinylidene fluoride/hexafluoropropylene copolymer, polyvinylidene fluoride (PVDF), polyacrylonitrile, polymethyl methacrylate, polytetrafluoroethylene, a combination thereof, and a styrene butadiene rubber polymer. However, embodiments are not limited thereto. Any material available as a binder in the art may be used.

Examples of the solvent are N-methyl-pyrrolidone, acetone, and water. However, embodiments are not limited thereto. Any material available as a solvent in the art may be used.

The amounts of the negative active material, the conducting agent, the binder, and the solvent may be those levels as used in the manufacture of lithium batteries in the art. At least one of the conducting agent, the binder, and the solvent may be omitted depending on the use and structure of a lithium battery.

Next, a protected positive electrode is prepared.

The protected positive electrode may be manufactured in the same manner as the negative electrode, except that a protective layer is formed on a surface of a positive electrode, and a positive active material, instead of a negative active material, is used.

A positive electrode slurry composition may be prepared using a conducting agent, a binder, and a solvent that may be the same as those used in the negative electrode slurry composition. In particular, a positive active material, a conducting agent, a binder, and a solvent may be mixed to prepare a positive electrode slurry composition. The positive electrode slurry composition may be directly coated on an aluminum current collector and dried, to thereby manufacture a positive electrode plate with a positive electrode thereon. In some embodiments, the positive electrode slurry composition may be cast on a separate support to form a positive active material film. The positive active material film may then be separated from the support and then laminated on an aluminum current collector, to thereby manufacture a positive electrode plate with a positive electrode thereon.

In some embodiments, a boron-containing anion receptor and a block copolymer may be added to the positive electrode slurry composition. In this case, a positive electrode including the boron-containing anion receptor and the block copolymer may be formed without a positive electrode. In some other embodiments, a protective layer as described above may also be formed on the positive electrode including the boron-containing anion receptor and the block copolymer.

The protective layer including the boron-containing anion receptor and the block copolymer may be formed on a surface of the positive electrode by dipping the positive electrode plate in a coating solution including the boron-containing anion receptor and the block copolymer, and drying the positive electrode plate after being taken from the coating solution. This dipping and drying process may be repeated several to several tens of times.

The coating solution may further include a lithium salt. The coating solution may further include a cross-linkable oligomer if needed. When the coating solution further includes a cross-linkable oligomer, a thermal treatment or UV treatment may be performed after forming the protective layer, to further incorporate a polymer network into the protective layer and/or the positive electrode. The order and number of the processes of forming the protective layer on the positive electrode and incorporating the polymer network into the protective layer and/or the positive electrode may be appropriately varied or controlled according to desired physical characteristics of the positive electrode.

The positive active material may be, for example, a lithium metal oxide. Any lithium metal oxide available in the art may be used. For example, a composite oxide of lithium with at least one selected from cobalt, manganese, nickel, and a combination thereof may be used, for example, a compound represented by one of the following formulae: LiₐA_{1-b}B′_{b}D′₂ (wherein 0.90≦a≦1.8, and 0≦b≦0.5); LiₐE_{1-b}B′_{b}O_{2-c}D′_{c} (wherein 0.90≦a≦1.8, 0≦b≦0.5, and 0≦c≦0.05); LiE_{2-b}B′_{b}O_{4-c}D′_{c} (wherein 0≦b≦0.5, and 0≦c≦0.05); LiₐNi_{1-b-c}Co_{b}B′_{c}D′_{α} (wherein 0.90≦a≦1.8, 0≦b≦0.5, 0≦c≦0.05, and 0<α≦2); LiₐNi_{1-b-c}Co_{b}B′_{c}O_{2-α}F′_{α} (wherein 0.90≦a≦1.8, 0≦b≦0.5, 0≦c≦0.05, and 0<α<2); LiₐNi_{1-b-c}Co_{b}B′_{c}O_{2-α}F′₂ (wherein 0.90≦a≦1.8, 0≦b≦0.5, 0≦c≦0.05, and 0<α<2); LiₐNi_{1-b-c}Mn_{b}B′_{c}D′_{α} (wherein 0.90≦a≦1.8, 0≦b≦0.5, 0≦c≦0.05, and 0<α≦2); LiₐNi_{1-b-c}Mn_{b}B′_{c}O_{2-α}F′_{α} (wherein 0.90≦a≦1.8, 0≦b≦0.5, 0≦c≦0.05, and 0<α<2); LiₐNi_{1-b-c}Mn_{b}B′_{c}O_{2-α}F′₂ (wherein 0.90≦a≦1.8, 0≦b≦0.5, 0≦c≦0.05, and 0<α<2); LiₐNi_{b}E_{c}G_{d}O₂ (wherein 0.90≦a≦1.8, 0≦b≦0.9, 0≦c≦0.5, and 0.001≦d≦0.1); LiₐNi_{b}Co_{c}Mn_{d}GeO₂ (wherein 0.90≦a≦1.8, 0≦b≦0.9, 0≦c≦0.5, 0≦d≦0.5, and 0.001≦e≦0.1); LiₐNiG_{b}O₂ (wherein 0.90≦a≦1.8, and 0.001≦b≦0.1); LiₐCoG_{b}O₂ (wherein 0.90≦a≦1.8, and 0.001≦b≦0.1); LiₐMnG_{b}O₂ (wherein 0.90≦a≦1.8, and 0.001≦b≦0.1); LiₐMn₂G_{b}O₄ (wherein 0.90≦a≦1.8, and 0.001≦b≦0.1); QO₂; QS₂; LiQS₂; V₂O₅; LiV₂O₅; LiI′O₂; LiNiVO₄; Li_{(3-f)}J₂(PO₄)₃ (wherein 0≦f≦2); Li_{(3-f)}Fe₂(PO₄)₃ (wherein 0≦f≦2); and LiFePO₄.

In the above formulae, A may be Ni, Co, Mn, or a combination thereof; B′ may be Al, Ni, Co, Mn, Cr, Fe, Mg, Sr, V, a rare earth element, or a combination thereof; D′ may be O, F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof.

For example, the positive active material may be Li[LiₐNi_{1-x-y-a}COₓMn_{y}]O₂ (wherein 0<a≦0.2, 0≦x≦0.5, and 0≦y≦0.5), LiCoO₂, LiMnₓO₂ₓ (wherein x=1 or 2), LiNi₁₋ₓMnₓO₂ₓ (wherein 0<x<1), LiNi_{1-x-y}CoₓMn_{y}O₂ (wherein 0≦x≦0.5, and 0≦y≦0.5), or LiFePO₄.

The compounds listed above as positive active materials may have a surface coating layer (hereinafter, also referred to as “coating layer”). Alternatively, a combination of a compound without a coating layer and a compound having a coating layer, the compounds being selected from the compounds listed above, may be used. In some embodiments, the coating layer may include at least one compound of a coating element selected from oxide, hydroxide, oxyhydroxide, oxycarbonate, and hydroxycarbonate of the coating element. In some embodiments, the compounds for the coating layer may be amorphous or crystalline. In some embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a combination thereof. In some embodiments, the coating layer may be formed using any method that does not adversely affect the physical properties of the positive active material when a compound of the coating element is used. For example, the coating layer may be formed using a spray coating method, or a dipping method. The coating methods may be well understood by one of ordinary skill in the art, and thus, a detailed description thereof will be omitted.

The amounts of the positive active material, the conducting agent, the binder, and the solvent may be the amounts that are commonly used in lithium batteries.

Next, a separator to be disposed between the protected positive electrode and the negative electrode is prepared. The separator may be omitted.

The separator may be any separator that is commonly used in lithium batteries. In some embodiments, the separator may have low resistance to migration of ions in an electrolyte and have an excellent electrolyte-retaining ability. Examples of the separator are glass fiber, polyester, Teflon, polyethylene, polypropylene, polytetrafluoroethylene (PTFE), and a combination thereof, each of which may be a non-woven or woven fabric. For example, a rollable separator including polyethylene or polypropylene may be used for a lithium ion battery. A separator with a good organic electrolytic solution-retaining ability may be used for a lithium ion polymer battery. For example, the separator may be manufactured in the following manner.

In some embodiments, a polymer resin, a filler, and a solvent may be mixed together to prepare a separator composition. Then, the separator composition may be directly coated on an electrode, and then dried to form the separator. In some embodiments, the separator composition may be cast on a support and then dried to form a separator film, which may then be separated from the support and laminated on an electrode to form the separator.

The polymer resin used to manufacture the separator may be any material that is commonly used as a binder for electrode plates. Examples of the polymer resin are a vinylidene fluoride/hexafluoropropylene copolymer, PVDF, polyacrylonitrile, polymethylmethacrylate, and a combination thereof.

Next, an electrolyte to be disposed between the protected positive electrode and the negative electrode is prepared.

The electrolyte to be disposed between the protected positive electrode and the negative electrode may include, for example, a liquid electrolyte, a gel electrolyte, a solid polymer electrolyte, a solid inorganic electrolyte, or a combination thereof.

For example, as the liquid electrolyte, an organic electrolyte solution may be prepared. The organic electrolyte solution may be prepared by dissolving a lithium salt in an ionic liquid and/or an organic solvent.

The ionic liquid may be any ionic liquid available in the art, for example, Pyr13FSI (N-propyl, N-methyl pyrrolidinium, bis(fluorosulfonyl)imide), Pyr14FSI (N-butyl, N-methyl pyrrolidinium, bis(fluorosulfonyl)imide), Pyr13TFSI (N-propyl, N-methyl pyrrolidinium, bis(trifluoromethanesulfonyl)imide), Pyr14TFSI (N-butyl, N-methyl pyrrolidinium, bis(trifluoromethanesulfonyl)imide), Pyr13TBETI (N-propyl, N-methyl pyrrolidinium, bis(pentafluoroethanesulfonyl)imide), Pyr14BETI (N-butyl, N-methyl pyrrolidinium, bis(pentafluoroethanesulfonyl)imide), Pyr13IM14 (N-propyl, N-methyl pyrrolidinium, bis(nonafluorobutyl-sulfonyl)imide), Pyr14IM14 (N-butyl, N-methyl pyrrolidinium, bis(nonafluorobutyl-sulfonyl)imide), or a combination thereof.

The organic solvent may be any solvent available as an organic solvent in the art. In some embodiments, the organic solvent may be propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl iso-propyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethyl formamide, dimethyl acetamide, dimethyl sulfoxide, dioxane, 1,2-dimethoxyethane, sulfolane, dichloroethane, chlorobenzene, nitrobenzene, diethylene glycol, dimethyl ether, or a combination thereof.

In some embodiments, the lithium salt may be any material available as a lithium salt in the art. In some embodiments, the lithium salt may be, for example, LiSCN, LiN(CN)₂, LiClO₄, LiBF₄, LiAsF₆, LiPF₆, LiCF₃SO₃, Li(CF₃SO₂)₂N, Li(CF₃SO₂)₃C, LiN(SO₂F)₂, LiN(SO₂C₂F₅)₂, LiN(SO₂CF₃)₂, LiN(SO₂CF₂CF₃)₂, LiSbF₆ and LiPF₃(CF₂CF₃)₃, LiPF₃(C₂F₅)₃, LiPF₃(CF₃)₃, LiB(C₂O₄)₂, NaSCN, NaSO₃CF₃, KTFSI, NaTFSI, Ba(TFSI)₂, Pb(TFSI)₂, Ca(TFSI)₂, or a combination thereof.

In some embodiments, a solid electrolyte may be used. For example, the solid electrolyte may be a solid organic electrolyte and/or a solid inorganic electrolyte.

The solid organic electrolyte may be, for example, a solid polymer electrolyte. The solid polymer electrolyte may be, for example, a polyethylene derivative, a polyethylene oxide derivative, a polypropylene oxide derivative, a phosphoric acid ester polymer, polyagitation lysine, polyester sulfide, polyvinyl alcohol, PVDF, or a polymer including an ionically dissociative group.

The solid inorganic electrolyte may be, for example, Li₃N, LiI, Li₅NI₂, Li₃N—LiI—LiOH, Li₂SiS₃, Li₄SiO₄, Li₄SiO₄—LiI—LiOH, Li₃PO₄—Li₂S—SiS₂, Cu₃N, LiPON, Li₂S.GeS₂.Ga₂S₃, Li₂O.11Al₂O₃, (Na, Li)₁₊ₓTi₂₋ₓAlₓ(PO₄)₃ (wherein 0.1≦x≦0.9), Li₁₊ₓHf₂₋ₓAlₓ(PO₄)₃ (wherein 0.1≦x≦0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (wherein M may be a rare earth element, such as Nd, Gd, or Dy) Li₅ZrP₃O₁₂, Li₅TiP₃O₁₂, Li₃Fe₂P₃O₁₂, Li₄NbP₃O₁₂, Li₁₊ₓ(M, Al, Ga)ₓ(Ge_{1-y}Ti_{y})₂₋ₓ(PO₄)₃ (wherein x≦0.8, 0≦y≦1.0, and M may be Nd, Sm, Eu, Gd, Tb, Dy, Ho, Er, Tm, or Yb), Li_{1+x+y}QₓTi₂₋ₓSi_{y}P_{3-y}O₁₂ (wherein 0<x≦0.4, 0<y≦0.6, and Q may be Al or Ga), Li₆BaLa₂Ta₂O₁₂, Li₇La₃Zr₂O₁₂, Li₅La₃Nb₂O₁₂, Li₅La₃M₂O₁₂ (wherein M may be Nb or Ta), or Li₇₊ₓAₓLa₃₋ₓZr₂O₁₂ (wherein 0<x<3, and A may be Zn).

The gel electrolyte may be any electrolyte in gel form available in the art. The gel electrolyte may include, for example, a polymer and a polymeric ionic liquid. The polymer may be, for example, a solid graft (block) co-polymer electrolyte.

Next, a lithium battery is assembled.

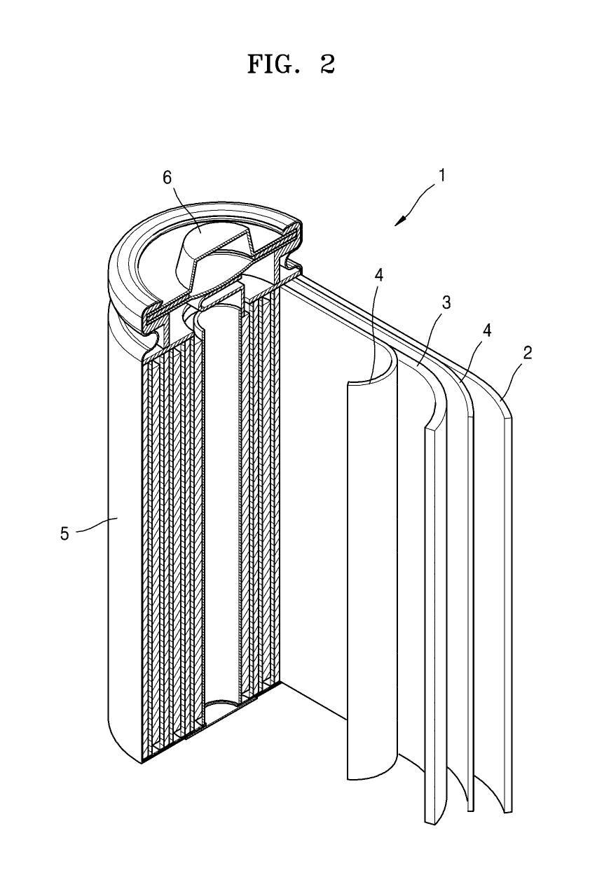

FIG. 2 is a schematic diagram of a lithium battery according to another embodiment. Referring to FIG. 2, a lithium battery 1 may include a protected positive electrode 3, a negative electrode 2, and a separator 4. The protected positive electrode 3, the negative electrode 2, and the separator 4 as described above may be wound, stacked, or folded, and then accommodated in a battery case 5. Subsequently, an organic electrolyte solution may be injected into the battery case 5, followed by sealing the battery case 5 with a cap assembly 6, thereby completing the manufacture of the lithium battery 1. Although not shown in FIG. 2, an electrolyte membrane including a composite electrolyte may be on a surface of the negative electrode 2 opposite to the protected positive electrode 3. The battery case 5 may have a cylindrical, rectangular, pouch, or thin film shape. For example, the lithium battery 1 may be a thin film-type battery or a lithium ion battery.

In some embodiments, the separator 4 may be disposed between the protected positive electrode 3 and the negative electrode 2 to form a battery assembly. In some embodiments, the battery assembly may be stacked to form a bi-cell structure and then impregnated with an organic electrolyte solution, followed by placing the resulting structure in a pouch and hermetically sealing the pouch, thereby completing the manufacture of a lithium ion polymer battery.

In some other embodiments, a plurality of such battery assemblies may be stacked upon one another to form a battery pack. The battery pack may be used in any device that requires high capacity and high power output, such as a laptop computer, a smart phone, an electric vehicle (EV), or the like.

In some embodiments, a lithium battery according to any of the embodiments is not limited to a lithium ion battery or a lithium polymer battery. For example, the lithium battery may be a lithium air battery or a lithium solid battery. For example, the lithium battery may be a lithium primary battery or a lithium secondary battery.

Functional groups and substituents in the formulae above herein may be defined as follows.

As used herein, the term “alkyl” refers to a completely saturated branched or unbranched (or straight-chained or linear) hydrocarbon group. Non-limiting examples of the “alkyl” group are methyl, ethyl, n-propyl, iso-propyl, n-butyl, iso-butyl, sec-butyl, n-pentyl, iso-pentyl, neo-pentyl, iso-amyl, n-hexyl, 3-methylhexyl, 2,2-dimethylpentyl, 2,3-dimethylpentyl, and n-heptyl.

At least one hydrogen atom of the alkyl group may be substituted with a halogen atom, a C1-C20 alkyl group substituted with a halogen atom (for example, CF₃, CHF₂, CH₂F, CCl₃, and the like), a C1-C20 alkoxy group, a C2-C20 alkoxyalkyl group, a hydroxyl group, a nitro group, a cyano group, an amino group, an amidino group, a hydrazine group, a hydrazone group, a carboxyl group or a salt thereof, a sulfonyl group, a sulfamoyl group, a sulfonic acid group or a salt thereof, a phosphoric acid group or a salt thereof, a C1-C20 alkyl group, a C2-C20 alkenyl group, a C2-C20 alkynyl group, a C1-C20 heteroalkyl group, a C6-C20 aryl group, a substituted or unsubstituted C6-C20 aryloxy group, a C6-C20 arylalkyl group, a C6-C20 heteroaryl group, a C7-C20 heteroarylalkyl group, a C6-C20 heteroaryloxy group, a C6-C20 heteroaryloxyalkyl group, or a C6-C20 heteroarylalkyl group.

The term “halogen atom” indicates fluorine, bromine, chloride, and iodine.

The term “C1-C20 alkyl group substituted with a halogen atom” indicates a C1-C20 alkyl group substituted with at least one halo group. Non-limiting examples of the C1-C20 alkyl group substituted with a halogen atom include polyhaloalkyl groups including a monohaloalkyl group, a dihaloalkyl group, or a perhaloalkyl group.

Monohaloalkyl groups indicate alkyl groups including one iodine, bromine, chloride, or fluoride. Dihaloalkyl groups and polyhaloalkyl groups indicate alkyl groups including at least two identical or different halo atoms.

As used herein, the term “alkoxy” represents “alkyl-O—”, wherein the alkyl is the same as described above. Non-limiting examples of the alkoxy group include methoxy, ethoxy, propoxy, 2-propoxy, butoxy, tert-butoxy, pentyloxy, hexyloxy, cyclopropoxy, and cyclohexyloxy. At least one hydrogen atom of the alkoxy group may be substituted with the same substituents as those recited above in conjunction with the alkyl group.

As used herein, the term “alkoxyalkyl” indicates an alkoxy-substituted alkyl group, wherein the terms “alkoxy” and “alkyl” are the same as described above. At least one hydrogen atom of the alkoxyalkyl group may be substituted with substituents that are the same as those recited above in conjunction with the alkyl group. Non-limiting examples of the alkoxy group include methoxyethyl and ethoxyethyl. As defined above, the term “alkoxyalkyl” may refer to substituted alkoxyalkyl moieties.

As used herein, the term “alkenyl” group indicates a branched or unbranched hydrocarbon having at least one carbon-carbon double bond. Non-limiting examples of the alkenyl group are vinyl, aryl, butenyl, iso-propenyl, and iso-butenyl. At least one hydrogen atom in the alkenyl group may be substituted with any of the substituents for the alkyl group as described above.

As used herein, the term “alkynyl” indicates a branched or unbranched hydrocarbon having at least one carbon-carbon triple bond. Non-limiting examples of the “alkynyl” group are ethynyl, butynyl, iso-butynyl, and iso-propynyl. At least one hydrogen atom of the “alkynyl” group may be substituted with any of the substituents for the alkyl group as described above.

As used herein, the term “aryl” group, which is used alone or in combination, indicates an aromatic hydrocarbon containing at least one ring. The term “aryl” is construed as including a group with an aromatic ring fused to at least one carbocyclic group cycloalkyl ring. Non-limiting examples of the “aryl” group are phenyl, naphthyl, and tetrahydronaphthyl. At least one hydrogen atom of the “aryl” group may be substituted with any of the substituents for the alkyl group as described above.

The term “arylalkyl” indicates an alkyl group substituted with an aryl group, wherein the terms “alkyl” and “aryl” are the same as described above. Examples of the “arylalkyl” group are benzyl and phenyl-CH₂CH₂—.

As used herein, the term “aryloxy” indicates “—O-aryl”. An example of the aryloxy group is phenoxy. At least one hydrogen atom of the “aryloxy” group may be substituted with substituents that are the same as those recited above in conjunction with the alkyl group.

As used herein, the term “heteroaryl” group indicates a monocyclic or bicyclic organic compound including at least one heteroatom selected from among nitrogen (N), oxygen (O), phosphorous (P), and sulfur (S), wherein the rest of the cyclic atoms are all carbon. The heteroaryl group may include, for example, one to five heteroatoms, and in some embodiments, may include a five- to ten-membered ring. In the heteroaryl group, S or N may be present in various oxidized forms.

At least one hydrogen atom of the heteroaryl group may be substituted with the same substituents as those recited above in conjunction with the alkyl group.

The term “heteroarylalkyl” group indicates an alkyl group substituted with a heteroaryl group, wherein the terms “alkyl” and “heteroaryl” are the same as described above.

The term “heteroaryloxy” group indicates a “—O-heteroaryl moiety”. At least one hydrogen atom of the heteroaryloxy group may be substituted with the same substituents as those recited above in conjunction with the alkyl group.

The term “heteroaryloxyalkyl” group indicates an alkyl group substituted with a —O-heteroaryl moiety. At least one hydrogen atom of the heteroaryloxyalkyl group may be substituted with the same substituents as those recited above in conjunction with the alkyl group.

As used herein, the term “carbocyclic” group indicates a saturated or partially unsaturated non-aromatic monocyclic, bicyclic, or tricyclic hydrocarbon group. Non-limiting examples of the carbocyclic group are a cyclopentyl group, a cyclopentenyl group, a cyclohexyl group, a cyclohexenyl group, and an adamantyl group. At least one hydrogen atom of the “carbocyclic group” may be substituted with substituents that are the same as those recited above in conjunction with the alkyl group.

As used herein, the term “heterocyclic group” indicates a five- to ten-membered ring including a heteroatom such as N, S, P, or O. An example of the heterocyclic group is pyridyl. At least one hydrogen atom in the heterocyclic group may be substituted with substituents that are the same as those recited above in conjunction with the alkyl group.

The term “heterocyclic oxy” indicates “—O-hetero ring”. At least one hydrogen atom of the heterocyclic oxy group may be substituted with the same substituents as those recited above in conjunction with the alkyl group.

The term “sulfonyl” indicates R″—SO₂—, where R″ is a hydrogen atom, an alkyl group, an aryl group, a heteroaryl group, an aryl-alkyl group, a heteroaryl-alkyl group, an alkoxy group, an aryloxy group, a cycloalkyl group, or a heterocyclic group.

The term “sulfamoyl” group refers to H₂NS(O₂)—, alkyl-NHS(O₂)—, (alkyl)₂NS(O₂)-aryl-NHS(O₂)—, alkyl(aryl)-NS(O₂)—, (aryl)₂NS(O)₂, heteroaryl-NHS(O₂)—, (aryl-alkyl)-NHS(O₂)—, or (heteroaryl-alkyl)-NHS(O₂)—. At least one hydrogen atom of the sulfamoyl group may be substituted with the same substituents as those described above in conjunction with the alkyl group.

The term “amino group” indicates a group with a nitrogen atom covalently bonded to at least one carbon or hetero atom. The amino group may refer to, for example, —NH₂ and substituted moieties. The term “amino group” also refers to an “alkylamino group” with nitrogen bound to at least one additional alkyl group, and “arylamino group” and “diarylamino group” with at least one or two nitrogen atoms bound to a selected aryl group.

When a group containing a specified number of carbon atoms is substituted with any of the groups listed in the preceding paragraph, the number of carbon atoms in the resulting “substituted” group is defined as the sum of the carbon atoms contained in the original (unsubstituted) group and the carbon atoms (if any) contained in the substituent. For example, when the term “substituted C1-C30 alkyl” refers to a C1-C30 alkyl group substituted with C6-C30 aryl group, the total number of carbon atoms in the resulting aryl substituted alkyl group is C7-C60.

A C rate is a discharge rate of a cell, and is obtained by dividing a total capacity of the cell by a total discharge period of time, e.g., a C rate for a battery having a discharge capacity of 1.6 ampere-hours would be 1.6 amperes.

One or more embodiments of the present disclosure will now be described in detail with reference to the following examples. However, these examples are only for illustrative purposes and are not intended to limit the scope of the one or more embodiments of the present disclosure.

### Examples

### Manufacture of Protected Positive Electrode

### Comparative Preparation Example 1: Preparation of Protective Layer-Forming Composition (Hereinafter “SAN”)

A polystyrene-b-polyacrylonitrile (PS-b-PAN) block copolymer (available from Sigma-Aldrich, 182850, CAS No. 9003-54-7) was added to anhydrous tetrahydrofuran to obtain a 5 percent by weight (wt %) of a block copolymer-containing mixture. The amount of the polystyrene block in the block copolymer was about 75 parts by weight, and the amount of the polyacrylonitrile block was about 25 parts by weight, based on 100 parts by weight of a total weight of the block copolymer. The block copolymer had a weight average molecular weight of about 165,000 Daltons.

Lithium bis(fluorosulfonyl) imide (LiFSI, LiN(SO₂F)₂) was added to the block copolymer-containing mixture to prepare a protective layer-forming composition. The amount of LiFSI was about 30 parts by weight based on 100 parts by weight of the block copolymer.

### Preparation Example 1: Preparation of Protective Layer-Forming (Hereinafter “SAN-TMB”)

Trimethyl borate (TMB) was further added to the protective layer-forming composition of Comparative Preparation Example 1 to prepare a protective layer-forming composition. The amount of TMB was about 10 parts by weight based on 100 parts by weight of the block copolymer.

### Preparation Example 2: Preparation of Protective Layer-Forming Composition (Hereinafter “SAN-TMSB”)

Tris(trimethylsilyl)borate (TMSB) was further added to the protective layer-forming composition of Comparative Preparation Example 1 to prepare a protective layer-forming composition. The amount of TMSB was about 10 parts by weight based on 100 parts by weight of the block copolymer.

Manufacture of Protected Positive Electrode and Lithium Battery

### Comparative Example 1: Bare Positive Electrode

LiCoO₂ powder and a carbon conducting agent (Super-P; Timcal Ltd.) were homogeneously mixed in a weight ratio of about 97:1.5, and a PVDF solution as a binder was added to the mixture to prepare a positive electrode slurry with a weight ratio of the positive active material, the carbon conducting agent, and the binder of about 97:1.5:1.5.

The prepared positive electrode slurry was coated on an aluminum substrate (having a thickness of about 15 micrometers) as a current collector with a doctor blade, dried at about 120° C. under reduced pressure, and then roll-pressed, to thereby manufacture a positive electrode as a sheet on the current collector.

The positive electrode and a lithium metal negative electrode (having a thickness of about 20 micrometers) were assembled with an electrolyte therebetween to manufacture a lithium battery (pouch cell) having a theoretical discharge capacity of about 34 milliampere hours (mAh).

A polyethylene/polypropylene separator was placed between the positive electrode and the lithium metal negative electrode, and a liquid electrolyte was injected into the separator. The liquid electrolyte used was an electrolyte solution of 1 molar (M) LiFSI dissolved in a mixed solvent of 1,2-dimethylethane (DME) and 1,1,2,2,-tetrafluoroethyl-2,2,3,3-tetrafluoropropyl ether (TTE) in a volume ratio of about 2:8.

### Comparative Example 2: SAN-Coated Protected Positive Electrode

After a surface of the positive electrode prepared in Comparative Example 1 was coated with the protective layer-forming composition of Comparative Preparation Example 1 by dipping the positive electrode in the protective layer-forming composition for about 1 hour, the coated positive electrode was taken out of the protective layer-forming composition, dried in the air at room temperature for about 2 hours, and dried further under vacuum at about 40° C. for about 1 hour, thereby manufacturing a protected positive electrode with a protective layer on the surface of the positive electrode. The protective layer had a thickness of about 100˜500 nanometers (nm).

A lithium battery (pouch cell) was manufactured in the same manner as in Comparative Example 1, except that the protected positive electrode, instead of the positive electrode of Comparative Example 1, was used.

### Comparative Example 3: Bare NCA Positive Electrode

A lithium battery (pouch cell) was manufactured in the same manner as in Comparative Example 1, except that LiNi_{0.8}Co_{0.15}Al_{0.05}O₂ powder, instead of LiCoO₂ powder, was used to obtain the pouch cell having a discharge capacity of about 56 mAh.

### Comparative Example 4: Bare NCA Positive Electrode and DME/TTE+TMB Electrolyte

A lithium battery (pouch cell) was manufactured in the same manner as in Comparative Example 3, except that about 1 part by weight of TMB based on 100 parts by weight of the electrolyte solution was further added to the liquid electrolyte.

### Comparative Example 5: Bare NCA Positive Electrode and DME/TTE+TMSB Electrolyte

A lithium battery (pouch cell) was manufactured in the same manner as in Comparative Example 1, except that TMSB, instead of TMB, was used.

### Example 1: SAN-TMB-Coated Protected Positive Electrode

After a surface of the positive electrode prepared in Comparative Example 1 was coated with the protective layer-forming composition of Preparation Example 1 by dipping the positive electrode in the protective layer-forming composition for about 1 hour, the coated positive electrode was taken out of the protective layer-forming composition, dried in the air at room temperature for about 2 hours, and dried further under vacuum at about 40° C. for about 1 hour, thereby manufacturing a protected positive electrode with a protective layer on the surface of the positive electrode. The protective layer had a thickness of about 100˜500 nm.

A lithium battery (pouch cell) was manufactured in the same manner as in Comparative Example 1, except that the protected positive electrode, instead of the positive electrode of Comparative Example 1, was used.

### Example 2: SAN-TMSB-Coated Protected Positive Electrode

After a surface of the positive electrode prepared in Comparative Example 1 was coated with the protective layer-forming composition of Preparation Example 2 by dipping the positive electrode in the protective layer-forming composition for about 1 hour, the coated positive electrode was taken out of the protective layer-forming composition, dried in the air at room temperature for about 2 hours, and dried further under vacuum at about 40° C. for about 1 hour, thereby manufacturing a protected positive electrode with a protective layer on the surface of the positive electrode. The protective layer had a thickness of about 100˜500 nm.

A lithium battery (pouch cell) was manufactured in the same manner as in Comparative Example 1, except that the protected positive electrode, instead of the positive electrode of Comparative Example 1, was used.

### Evaluation Example 1: Cross-Section Analysis of Positive Electrode (by Scanning Electron Microscopy-Energy Dispersive Spectroscopy (SEM-EDS))

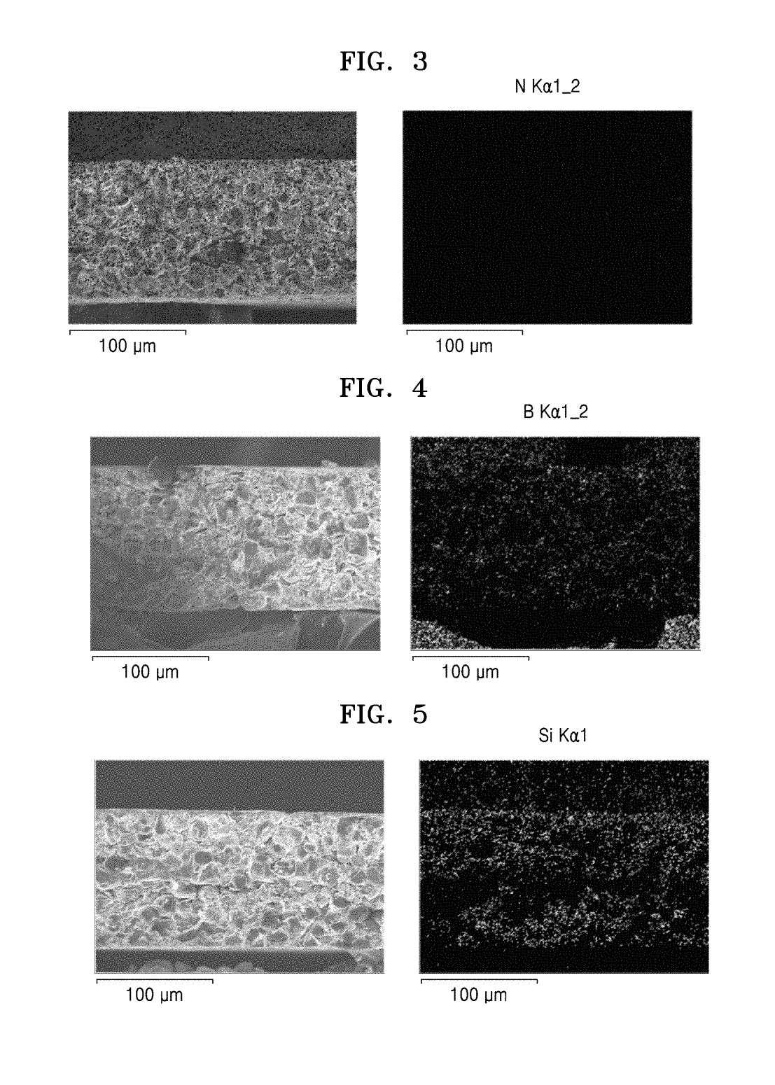

Coated statues and components of the protective layer on each of the protected positive electrodes of Comparative Example 2 and Examples 1 and 2 were analyzed using SEM-EDS. The SEM-EDS analysis results of the cross-sections of the protected positive electrodes of Comparative Example 2, Example 1, and Example 2 are shown in FIGS. 3 to 5, respectively.

Referring to FIGS. 3 to 5, the protective layer in the upper portion of each of the protected positive electrodes was found to have a thickness of less than about 500 nm. In the protected positive electrode of Comparative Example 2, the SAN block copolymer permeated deep into the positive electrode, with a uniform distribution of nitrogen (N) originating from SAN over the entire positive electrode. In the protected positive electrode of Example 1, the SAN block copolymer including an anion receptor TMB permeated deep into the positive electrode, with a uniform distribution of boron (B) originating from TMB over the entire positive electrode. In the protected positive electrode of Example 2, the SAN block copolymer including an anion receptor TMSB permeated deep into the positive electrode, with a uniform distribution of silicon (Si) originating from TMSB over the entire positive electrode.

### Evaluation Example 2: Impedance Measurement

The lithium batteries of Comparative Example 1, Comparative Examples 3 to 5, and Examples 1 and 2 were analyzed according to a 2-probe method using an impedance analyzer (Solartron 1260A Impedance/Gain-Phase Analyzer) at an amplitude of about 10 millivolts (mV) and in a frequency range of about 0.1 hertz (Hz) to 1 megahertz (MHz), to measure interfacial resistance of the protected positive electrode.

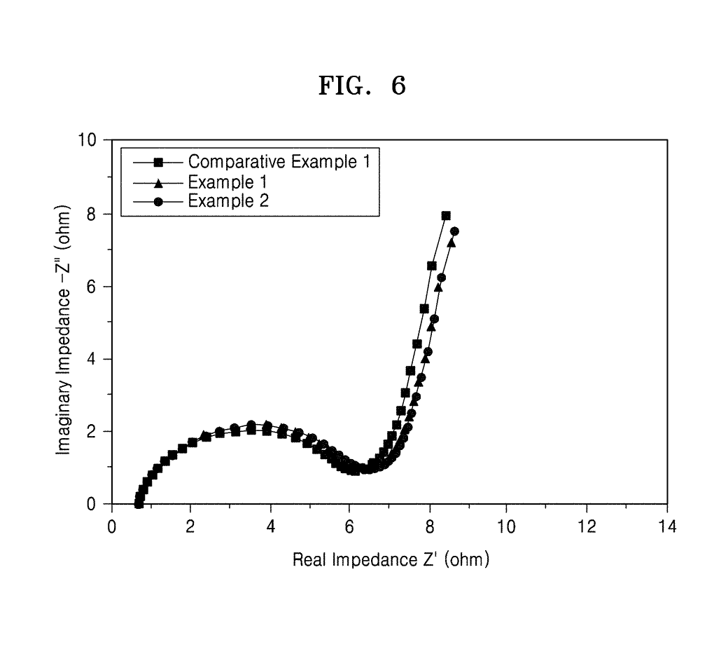

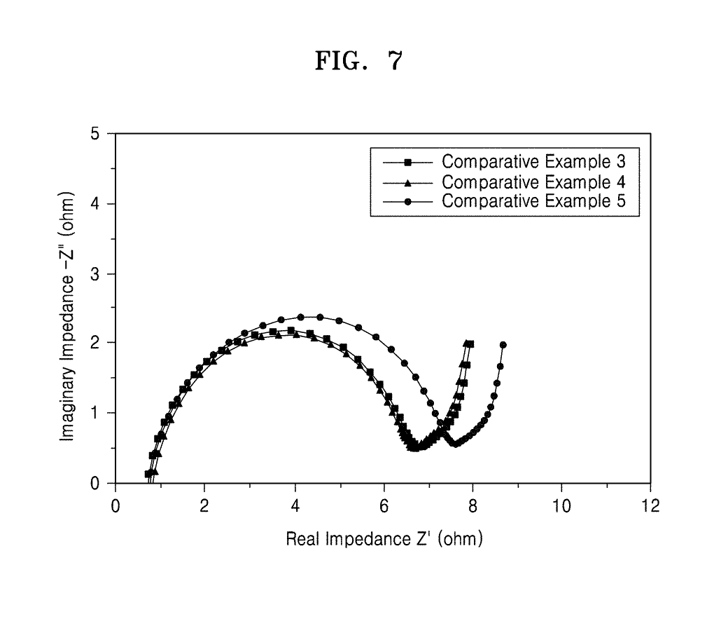

Nyquist plots obtained as the results of the impedance measurement that was performed after 3 hours from the manufacture of the lithium batteries of Comparative Example 1 and Examples 1 and 2 are shown in FIG. 6, and those of the lithium batteries of Comparative Examples 3 to 5 are shown in FIG. 7. In FIGS. 6 and 7, an interfacial resistance of an electrode depends from the position and size of the semicircle, and a difference between the left x-intercept and the right x-intercept of the semicircle represents the interfacial resistance.

Referring to FIG. 6, the lithium batteries of Examples 1 and 2 were found to have a slightly higher interfacial resistance, compared with the lithium battery of Comparative Example 1.

Referring to FIG. 7, the lithium battery of Comparative Example 4 was found to have nearly no difference in interfacial resistance from that of the lithium battery of Comparative Example 3, while the lithium battery of Comparative Example 5 was found to have a larger interfacial resistance, compared with the lithium battery of Comparative Example 5. Comparing the results of FIGS. 6 and 7, unlike when the protective layer was prepared by adding the anion receptor to the block copolymer, the interfacial cell performance deteriorated when the anion receptor was added to the ether-based liquid electrolyte.

### Evaluation Example 3: Lifetime Characteristics Evaluation

Each of the lithium batteries of Comparative Example 1 and Examples 1 and 2 was charged at about 25° C. with a constant current of 0.1 Coulomb (C) rate until a voltage of about 4.5 Volts (V) (with respect to Li), and then with a constant voltage of 4.50 V until a cutoff current of 0.05 C rate, and was then discharged with a constant current of 0.1 C rate to a voltage of about 3.0 V (with respect to Li) (Formation process, 1^{st} cycle). This cycle of charging and discharging was performed twice in total to complete the formation process.

Each of the lithium batteries after the formation process was charged at room temperature (25° C.) with a constant current of 0.2 C until a voltage of about 4.5 V (with respect to Li) and then with a constant voltage of about 4.50 V (with respect to Li) to a cutoff current of 0.1 C, and then discharged with a constant current of 0.2 C rate until a voltage of 3.0 V (with respect to Li). This cycle of charging and discharging was repeated 150 times in total, wherein the cycle of charging and discharging was stopped when a sharp reduction in discharge capacity occurred in the lithium battery.

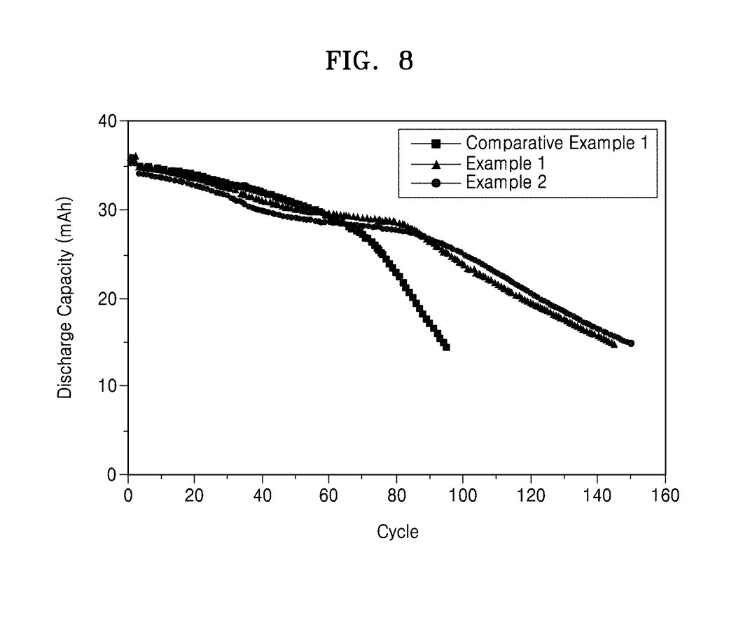

The results of the charge-discharge test are shown in FIG. 8.

Referring to FIG. 8, the lithium batteries of Examples 1 and 2 using a protected positive electrode coated with a boron-containing anion receptor and a block copolymer were found to have remarkably improved lifetime characteristics, compared to the lithium battery of Comparative Example 1 using the bare positive electrode.

### Evaluation Example 4: High-Rate Lifetime Characteristics Evaluation

Each of the lithium batteries of Comparative Example 1 and Example 1 was charged at about 25° C. with a constant current of 0.1 C rate to a voltage of about 4.5 V (with respect to Li), and then with a constant voltage of 4.5 V until a cutoff current of 0.1 C rate, and was then discharged with a constant current of 0.5 C rate until a voltage of about 3.0 V (with respect to Li) (Formation process, 1^{st} cycle). This cycle of charging and discharging was performed twice in total to complete the formation process.

Each of the lithium batteries after the formation process was charged at room temperature (25° C.) with a constant current of 0.7 C until a voltage of about 4.5 V (with respect to Li) and then with a constant voltage of about 4.50 V (with respect to Li) until a cutoff current of 0.1 C, and then discharged with a constant current of 0.5 C rate until a voltage of 3.0 V (with respect to Li). This cycle of charging and discharging was repeated 45 times in total, wherein the cycle of charging and discharging was stopped when a sharp reduction in discharge capacity occurred in the lithium battery.

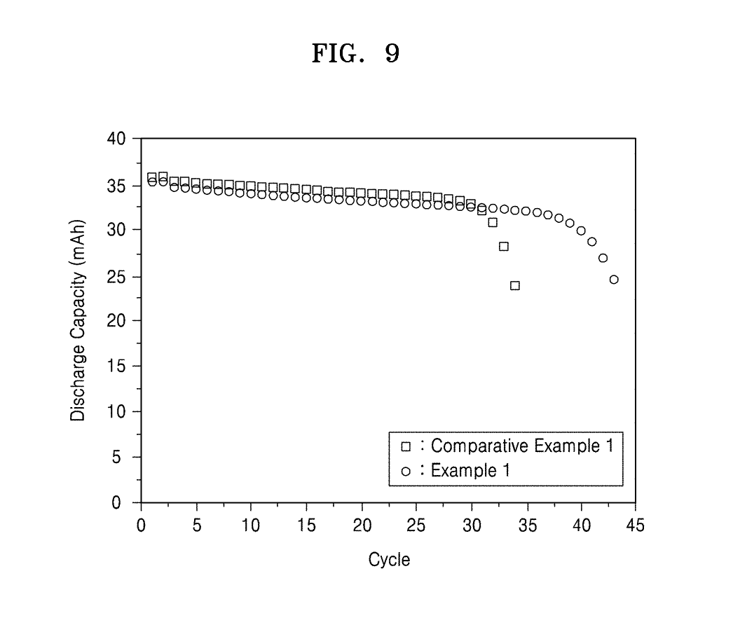

The results of the charge-discharge test are shown in FIG. 9.

Referring to FIG. 9, the lithium battery of Example 1 using a protected positive electrode coated with a boron-containing anion receptor and a block copolymer were found to have remarkably improved high-rate lifetime characteristics, compared to the lithium battery of Comparative Example 1 using the bare positive electrode.

### Evaluation Example 5: Performance Evaluation of Anion Receptor-Containing Electrolyte Solution

Each of the lithium batteries of Comparative Examples 3 to 5 was charged at about 25° C. with a constant current of 0.1 C rate to a voltage of about 4.4 V (with respect to Li), and then with a constant voltage of 4.4 V until a cutoff current of 0.05 C rate, and was then discharged with a constant current of 0.1 C rate until a voltage of about 3.0 V (with respect to Li) (Formation process, 1^{st} cycle). This cycle of charging and discharging was performed twice in total to complete the formation process.

Each of the lithium batteries after the formation process was charged at room temperature (25° C.) with a constant current of 0.5 C until a voltage of about 4.4 V (with respect to Li) and then with a constant voltage of about 4.4 V (with respect to Li) until a cutoff current of 0.1 C, and then discharged with a constant current of 0.5 C rate until a voltage of 3.0 V (with respect to Li). This cycle of charging and discharging was repeated 200 times in total, except when charging and discharging a lithium battery was stopped where a sharp reduction in discharge capacity occurred in the lithium battery.

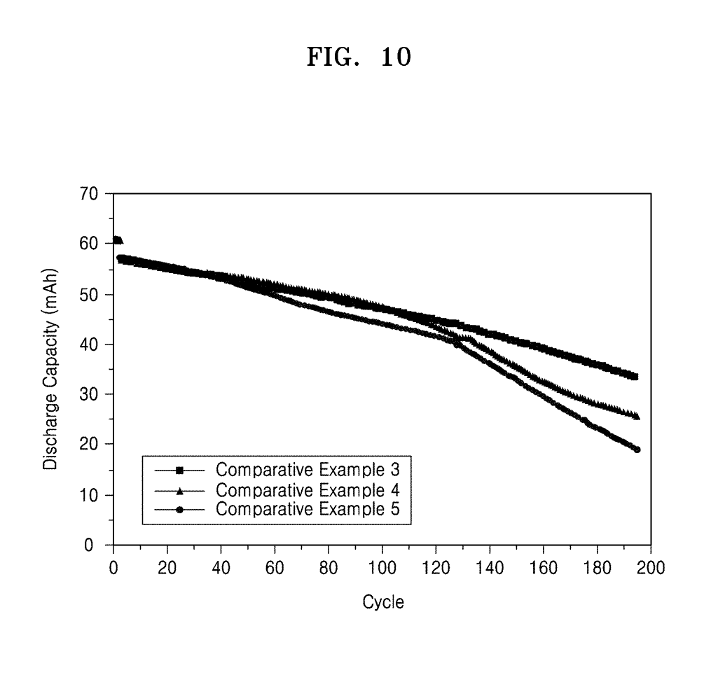

The results of the charge-discharge test are shown in FIG. 10.

Referring to FIG. 10, the lithium batteries of Comparative Examples 4 and 5, in which the boron-containing anode receptor was added to the liquid electrolyte, were found to have deteriorated lifetime characteristics, compared to the lithium battery of Comparative Example 3, in which an anode receptor was not used.

From these results, the boron-containing anion receptor does not seem to be an effective additive in an ether-based liquid electrolyte.

### Evaluation Example 6: Lithium Ion Mobility Evaluation

To evaluate an anion binding effect of boron (B)-based anion receptor, the following experiment was conducted.

Li/Li symmetric cells were manufactured using lithium metal thin films with the protective layers prepared in Comparative Example 2 and Example 2 thereon, respectively, and an electrolyte. The electrolyte used was a liquid electrolyte including 1.0 M LiFSI dissolved in a mixed solvent of 1,2-dimethoxyethane (DME) and 1,1,2,2-tetrafluoroethyl 2,2,3,3-tetrafluoropropyl ether (TTE) in a volume ratio of about 2:8.

For comparison, a Li/Li symmetric cell was manufactured using a bare lithium metal thin film and the electrolyte.

The lithium ion transference number (t_{Li+}) of each of the symmetric cells at about 25° C. was evaluated. Some of the results are shown in Table 1.

The lithium ion transference numbers of the symmetric cells were calculated using Equation 1. A current decay with time with respect to an impedance and an input voltage of a lithium symmetric cell were measured and used to calculate the lithium ion transference number (see, for example, Electrochimica Acta 93 (2013) 254, the content of which is incorporated herein in its entirety by reference).

$${t}_{{Li}^{+}} = \frac{iss ( Δ V - {i}_{0} {R}^{0} )}{{i}_{0} ( Δ V - {i}_{ss} {R}^{ss} )} \qquad Equation 1$$

In Equation 1,

i₀ indicates an initial current,

iₛₛ indicates a steady state current,

R⁰ indicates an initial resistance, R^{ss} indicates a steady state resistance, and

ΔV indicates a voltage difference.

TABLE 1

| Protective layer | Li⁺ transference number |
|---|---|
| Bare Li | 0.51-0.54 |
| SAN (Comparative Example 2) | 0.52-0.54 |
| SAN + TMSB (Example 2) | 0.61-0.63 |

Referring to Table 1, the protective layer of Example 2 was found to have a larger lithium ion transference number (t_{Li+}), and consequentially improved lithium ion mobility, compared to the bare lithium metal and the protective layer of Comparative Example 2.

As described above, according to the one or more embodiments, a lithium battery may include a positive electrode with a protective layer thereon including a boron-containing anion receptor and a block copolymer, and thus, have improved lifetime characteristics at high voltage.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the present disclosure as defined by the following claims.

What is claimed is:

1. A lithium battery comprising:
a negative electrode;
a protected positive electrode; and
an electrolyte disposed between the negative electrode and the protected positive electrode,
wherein the protected positive electrode comprises:
a positive electrode comprising a positive active material; and
a protective layer disposed on the positive electrode, wherein the protective layer comprises a boron-containing anion receptor and a block copolymer.

2. The lithium battery of claim 1, wherein the boron-containing anion receptor has a boron-containing Lewis acid structure.

3. The lithium battery of claim 1, wherein the boron-containing anion receptor comprises at least one compound selected from a borane compound, a borate compound, and a boron oxalate compound, each having a Lewis acid structure.

4. The lithium battery of claim 1, wherein the boron-containing anion receptor comprises at least one of compounds represented by Formula 1 to Formula 3: 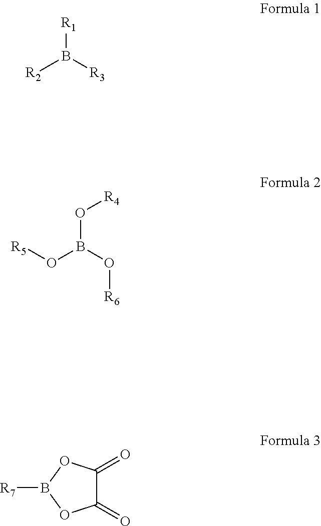
wherein, in Formulae 1, 2, and 3,
R₁ to R₇ are each independently a substituted or unsubstituted C1-C20 alkyl group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 aryl alkyl group, a substituted or unsubstituted C2-C20 heteroaryl group, a substituted or unsubstituted C2-C20 hetero aryloxy group, a substituted or unsubstituted C2-C20 heteroaryl alkyl group, a substituted or unsubstituted C4-C20 carbocyclic group, a substituted or unsubstituted C4-C20 carbocyclic alkyl group, a substituted or unsubstituted C2-C20 heterocyclic group, a substituted or unsubstituted C2-C20 heterocyclic alkyl group, a cyano group, a hydroxyl group, a cyano group, an amino group, an amidino group, a hydrazine group, a hydrazone group, a nitro group, a thiol group, a phosphate group, a silyl group, a carboxyl group or a salt thereof, a sulfonyl group, a sulfamoyl group, a sulfonic acid group or a salt thereof, or a phosphoric acid group or a salt thereof,
wherein any two of R₁ to R₃ are optionally connected to each other to form a ring, and
wherein any two of R₄ to R₆ are optionally connected to each other to form a ring.

5. The lithium battery of claim 1, wherein the boron-containing anion receptor comprises a compound represented by Formula 2a: 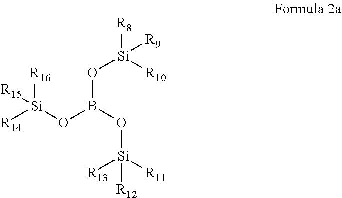
wherein, in Formula 2a,
R₈ to R₁₆ are each independently a substituted or unsubstituted C1-C20 alkyl group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 aryl alkyl group, a substituted or unsubstituted C2-C20 heteroaryl group, a substituted or unsubstituted C2-C20 hetero aryloxy group, a substituted or unsubstituted C2-C20 heteroaryl alkyl group, a substituted or unsubstituted C4-C20 carbocyclic group, a substituted or unsubstituted C4-C20 carbocyclic alkyl group, a substituted or unsubstituted C2-C20 heterocyclic group, or a substituted or unsubstituted C2-C20 heterocyclic alkyl group.

6. The lithium battery of claim 1, wherein the boron-containing anion receptor comprises a compound represented by Formula 3a: 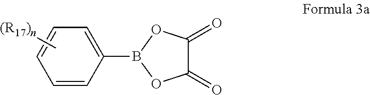
wherein, in Formula 3a,
R₁₇ is a fluorine-containing moiety, and
n is 1, 2, 3, 4, or 5.

7. The lithium battery of claim 6, wherein the fluorine-containing moiety is selected from fluorine, fluoromethyl, difluoromethyl, trifluoromethyl, 1-fluoroethyl, 1,1-difluoroethyl, 1,1,2-trifluoroethyl, 1,1,2,2-tetrafluoroethyl, and 1,1,1,2-tetrafluoroethyl.

8. The lithium battery of claim 1, wherein the boron-containing anion receptor comprises at least one selected from tris(pentafluorophenyl) borane, triphenyl borate, trimethyl borate, tris(trimethylsilyl) borate, tris(triethylsilyl) borate, tris(hexafluoroisopropyl) borate, pentafluorophenylboron oxalate, 2,4-difluorophenylboron oxalate, 2,5-difluorophenylboron oxalate, 2,3,6-trifluorophenylboron oxalate, and 3,5-bis(trifluoromethyl)phenylboron oxalate.

9. The lithium battery of claim 1, wherein the amount of the boron-containing anion receptor is from about 1 to 30 parts by weight based on 100 parts by weight of the block copolymer.

10. The lithium battery of claim 1, wherein the protected positive electrode further comprises a lithium salt, wherein an anion of the lithium salt is coordinated to the boron-containing anion receptor.

11. The lithium battery of claim 1, wherein the block copolymer comprises at least one first block that forms a structural domain and at least one second block that forms an ionically conductive domain,
wherein the amount of the at least one first block is from about 20 to about 80 parts by weight based on 100 parts by weight of the block copolymer, and
wherein the amount of the at least one second block is from about 20 parts to about 80 parts based on 100 parts by weight of the block copolymer.

12. The lithium battery of claim 11, wherein the at least one first block comprises at least one selected from polystyrene, hydrogenated polystyrene, polymethacrylate, poly(methyl methacrylate), polyvinylpyridine, polyvinylcyclohexane, polyimide, polyamide, polyethylene, polybutylene, polypropylene, poly(4-methylpentene-1), poly(butylene terephthalate), poly(iso-butyl methacrylate), poly(ethylene terephthalate), polydimethylsiloxane, polyacrylonitrile, polyvinylcyclohexane, polymaleic acid, polymaleic acid anhydride, polyamide, polymaleic acid, poly(tert-butyl vinyl ether), poly(cyclohexyl methacrylate), poly(cyclohexyl vinyl ether), polyvinylidene fluoride, polydivinylbenzene; or a copolymer comprising at least two repeating units thereof.

13. The lithium battery of claim 11, wherein the at least one second block comprises at least one selected from polyethylene oxide, polysiloxane, polyacrylonitrile, polyisoprene, polybutadiene, polychloroprene, polyisobutylene, and polyurethane.

14. The lithium battery of claim 1,
wherein the electrolyte comprises at least one solvent selected from an ether group-containing solvent and a carbonate group-containing solvent, and
wherein the block copolymer and the at least one solvent selected from an ether group-containing solvent and a carbonate group-containing solvent have a difference (Δδ) in solubility parameter of about 3 or greater.

15. The lithium battery of claim 1, wherein the protective layer further comprises an inorganic particle.

16. The lithium battery of claim 15, wherein the inorganic particle is at least one selected from Li_{1+x+y}AlₓTi₂₋ₓSi_{y}P_{3-y}O₁₂ (wherein 0<x<2 and 0≦y<3), Pb(Zr, Ti)O₃, Pb₁₋ₓLaₓZr_{1-y} Ti_{y}O₃ (wherein 0≦x<1, and 0≦y<1), Pb(Mg₃Nb_{2/3})O₃—PbTiO₃, HfO₂, SrTiO₃, SnO₂, CeO₂, Na₂O, MgO, NiO, CaO, BaO, ZnO, ZrO₂, Y₂O₃, SiC, Li₃PO₄, LiₓTi_{y}(PO₄)₃ (wherein 0<x<2 and 0<y<3), LiₓAl_{y}Ti_{z}(PO₄)₃ (wherein 0<x<2, 0<y<1, and 0<z<3), Li_{1+x+y}(Al, Ga)ₓ(Ti, Ge)₂₋ₓSi_{y}P_{3-y}O₁₂ (wherein 0≦x≦1 and 0≦y≦1), LiₓLa_{y}TiO₃ (wherein 0<x<2 and 0<y<3), LiₓGe_{y}P_{z}S_{w} (wherein 0<x<4, 0<y<1, 0<z<1, and 0<w<5), LiₓN_{y} (wherein 0<x<4 and 0<y<2), LiₓSi_{y}S_{z} (wherein 0<x<3, 0<y<2, and 0<z<4), LiₓP_{y}S_{z} (wherein 0<x<3, 0<y<3, and 0<z<7), Li₂O, LiF, LiOH, Li₂CO₃, LiAlO₂, Li₂O—Al₂O₃—SiO₂—P₂O₅—TiO₂—GeO₂-containing ceramics, and Li₃₊ₓLa₃M₂O₁₂ (wherein M may be at least one of Te, Nb, and Zr).

17. The lithium battery of claim 1, wherein the protective layer has a thickness of about 1 micrometer or less.

18. The lithium battery of claim 1, wherein the negative electrode comprises a lithium metal or a lithium alloy substrate.

19. The lithium battery of claim 1, wherein the electrolyte comprises a liquid electrolyte, a gel electrolyte, a solid polymer electrolyte, a solid inorganic electrolyte, or a combination thereof.

20. The lithium battery of claim 1, wherein a charging voltage is about 4.0 to 5.5 volts with respect to lithium metal.

21. A positive electrode slurry composition comprising a positive active material, a boron-containing anion receptor, and a block copolymer.

22. The positive electrode slurry composition of claim 21, wherein the boron-containing anion receptor has a boron-containing Lewis acid structure.

23. The positive electrode slurry composition of claim 21, wherein the boron-containing anion receptor comprises at least one of compounds represented by Formula 1 to Formula 3: 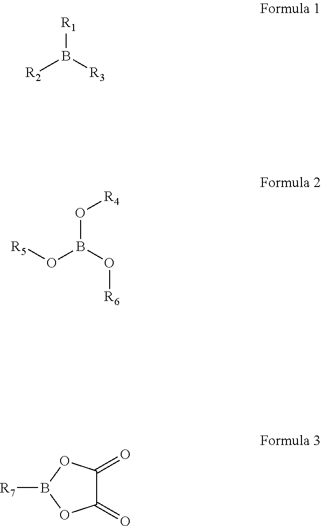
wherein, in Formulae 1, 2, and 3,
R₁ to R₇ are each independently a substituted or unsubstituted C1-C20 alkyl group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 aryl alkyl group, a substituted or unsubstituted C2-C20 heteroaryl group, a substituted or unsubstituted C2-C20 hetero aryloxy group, a substituted or unsubstituted C2-C20 heteroaryl alkyl group, a substituted or unsubstituted C4-C20 carbocyclic group, a substituted or unsubstituted C4-C20 carbocyclic alkyl group, a substituted or unsubstituted C2-C20 heterocyclic group, a substituted or unsubstituted C2-C20 heterocyclic alkyl group, a cyano group, a hydroxyl group, a cyano group, an amino group, an amidino group, a hydrazine group, a hydrazone group, a nitro group, a thiol, a phosphate, a silyl group, a carboxyl group or a salt thereof, a sulfonyl group, a sulfamoyl group, a sulfonic acid group or a salt thereof, or a phosphoric acid group or a salt thereof,
wherein any two of R₁ to R₃ are optionally connected to each other to form a ring, and
wherein any two of R₄ to R₆ are optionally connected to each other to form a ring.

24. The positive electrode slurry composition of claim 21,
wherein the amount of the boron-containing anion receptor is about 0.1 to 50 parts by weight based on 100 parts by weight of the positive active material, and
wherein the amount of the block copolymer is about 0.1 to 50 parts by weight based on 100 parts by weight of the positive active material.
